(19) United States
(12) Patent Application Publication
(10) Pub. No.: US 2016/0298695 A1
(43) Pub. Date: Oct. 13, 2016

(54) COUPLING

(71) Applicant: PUNK COUPLINGS LIMITED, Bristol (GB)

(72) Inventor: Simon PARKER, Bristol (GB)

(21) Appl. No.: 15/177,600

(22) Filed: Jun. 9, 2016

Related U.S. Application Data
(63) Continuation-in-part of application No. PCT/GB2014/053679, filed on Dec. 12, 2014.

(30) Foreign Application Priority Data
Dec. 13, 2013 (GB) 1322096.7
Jun. 11, 2015 (GB) 1510136.3
Jun. 11, 2015 (GB) 1510137.1
Oct. 22, 2015 (GB) 1518768.5

(51) Int. Cl. F16D 3/30

(52) U.S. Cl. CPC F16D 3/30; F16D 2300/06

(57) ABSTRACT

A coupling comprises a plurality of members, including an inner member and an outer member with one or more intermediate members arranged in pairs. One member of a pair constrained to rotate about a single axis relative to a member of the pair outside it, and in which the inner member of the pair is nested within the outer member of a pair. Members are formed as segments of spheres with a common centre point on a torsional axis though the inner member.

This application is a Continuation-in-Part of:
International Application No. PCT/GB2014/053679 filed in English on 12 Dec. 2014 claiming priority to GB Application No GB1322096.7 filed 13 Dec. 2013;
GB Application No. GB1510136.3 filed 11 Jun. 2015 in English; and
GB Application No. GB1510137.1 filed 11 Jun. 2015 in English; and
GB Application No. GB1518768.5 filed 22 Oct. 2015 in English.

The entire contents of these applications are incorporated herein by reference.

### TECHNICAL FIELD AND BACKGROUND

This invention relates to a coupling.

Mechanical couplings are well known. Examples include couplings for coupling angularly misaligned shafts, universal joints, constant velocity joints, couplings for coupling a drive shaft to a driven shaft, couplings for connecting a torque shaft to a structural element of, for example, a suspension system.

### SUMMARY OF THE INVENTION

According to the present invention a coupling having an inner member and an outer annular member comprises one or more pairs of members, which may or may not include one or both the innermost and outermost members, each pair being a first member and a second annular member with a common axis and having a common first centre on the axis;
the first member having an outer convex spherical periphery;
the second annular member having an inner spherical concave periphery into which the outer convex periphery of the first annular member is received;
the outer convex periphery and the inner concave peripheries being concentric about the first centre and complementary to one another and co-acting with one another to transmit axial loads acting along the torsional axis between them;
at least one elongate projection from one member of a pair of members into an elongate slot in the other of the pair of members, each projection and each slot being elongate in a plane containing or parallel to the central axis of the pair of members concerned, the slot and projection projecting in the direction of the said plane, and arranged to co-act with the pair of members to transmit torque from the innermost of the pair of members to the other member of the pair;
each member, other than the inner member, having a pair of diametrically opposed loading slots extending half way across their width to enable the introduction of the first member of a pair of members into the concave inner periphery of the second of the pair of members, and to be retained axially by the second of the pair of members.

For most practical applications the said members, other than the outer member, comprise spherical segments including a common centre.

A spherical segment is a portion of a sphere between with a pair of parallel planes. However, it is possible to consider, in some circumstances, situations in which a segment of a sphere is used in which the planes are not parallel but non-intersecting or which is cut by cones whose apexes are on the common axis—such alternatives would have disadvantages both in manufacture, assembly and use and seem less likely to be adopted.

Couplings according to the invention may be used for coupling any two structural elements that must be coupled with at least one rotational degree of freedom. Some examples are useful as ‘structural static couplings’ coupling an element to a fixed structure. Other examples are useful as rotational ‘flexible couplings’ coupling two rotational elements. By way of example, various couplings according to the invention may be used to couple angularly misaligned shafts, such as universal joints, constant velocity joints, couplings for coupling a drive shaft to a driven shaft, or as couplings for connecting a torque shaft to a fixed structural element, as in, for example, a suspension system.

The invention may be applied to Spragg or ratchet clutches. Spragg and ratchet clutches, themselves, are well known and well understood and have an inner and outer ring. In one direction of rotation there is no driving contact between the rings, in the other direction of rotation there is driving contact between the inner and outer ring and it is possible to transmit a high torque in this direction. These features allow diverse applications automatically; for example, they can be used in indexing applications, act as over running couplings and back stops.

For such an application in a coupling according to the invention the outer annular member comprises a Spragg or ratchet clutch or freewheel element.

The open design of the couplings discussed above can lead to loss of lubricant in wet lubricated versions of the couplings and in any version, whether wet lubricated of not, to the ingress of dust and grit, which leads to wear, especially of the projections, slots, axles and bores in which they operate.

In a further embodiment of the invention the coupling additionally comprises one or a pair of seal support member having mounted thereon one or more annular seals, the one or more seals engaging the spherical periphery of one of the said annular member inside the seal support member.

In one such embodiment the one or pair of seal support members comprise inwardly directed seal support rings, the seal support rings being mounted within a first of the annular members and the annular seals engaging the spherical periphery of a second of said annular member, said second annular member being inside the first annular member.

Where the coupling comprises an inner member, three intermediate members and an outer member, two pairs of seals and seal rings are provided, one pair of seal rings mounted inside the outer member and with their associated seals engaging the outer spherical periphery of the second of the intermediate members, and the second pair of seal rings mounted inside the inner periphery of the second intermediate member with the associated seals engaging the outer periphery of the inner member.

In a further embodiment, the outer annular member has a spherical outer periphery and the seal support member comprises a housing having an inner hemispherical surface extending partially around the outer member. The seal is mounted on the inner hemispherical surface of the housing and engaging the spherical outer periphery of the outer annular member.

When such coupling comprises one intermediate annular member, preferably the spherical outer periphery of the inner annular member, the spherical inner and outer peripheries of the both the intermediate annular member and the outer annular member and the inner hemispherical surface of the housing have a common centre and, ideally, the plane passing through the edge of the seal passes through the centre. However, the plane can pass through a point within the hemisphere which is off-set from the common centre but on the axis of the inner annular member.

In the further embodiment, ideally, the seal is mounted in a groove around the periphery of the inner hemispherical surface of the housing,

In the further embodiment, ideally, the housing extends beyond the seal parallel to the axis of the inner annular member.

Preferably in the further embodiment the housing is formed contiguously with an input/output hub of the coupling, said hub being connected the input or output of the coupling and projecting from the hub is a shaft and engaging with the first inner annular member of the coupling.

Preferably in the further embodiment the outer annular member is formed with a lateral cylindrical extension, said extension connecting with the other of the output or input of the coupling.

In the invention the intermediate ring(s) may have one or more ducts from the outer surface of each projection from the intermediate rings(s) to the sides of the intermediate rings. The purpose of the ducts, in a wet lubricated coupling is to duct lubricant from the sides of the intermediate ring(s) to the slot in which the projection operates.

In one arrangement the sides of intermediate member(s) incline inwards from the inner periphery of the member to the outer periphery of the member, the arrangement being such that at the rotation of the intermediate member brings one side or the other parallel to an adjacent seal support disc.

Other features of the invention are found in the claims and/or the accompanying description.

### BRIEF DESCRIPTION OF DRAWINGS

Examples of the invention are described below with reference to the to the accompanying drawings, in which:

FIG. 1 illustrates a reference frame of operation of couplings according to embodiments of the invention;

FIGS. 2A to 2D show an example of a coupling according to the invention, of which FIG. 2A is an isometric view of a coupling with its elements un-aligned, FIG. 2B is an axial side view of a coupling in the frame of reference, FIG. 2C is a cross-sectional view along axis A2 of FIG. 2B and FIG. 2D is a cross-sectional view along the axis A3 of FIG. 2B;

FIGS. 3A to 3E illustrate a method of assembling the coupling of FIG. 2;

FIGS. 4A and 4B show a hub centre steering mechanism including an example of a coupling in accordance with the invention;

FIGS. 5A and 5B are cross-sectional views of pairs of couplings connected together;

FIGS. 6A to 6C show another example of a coupling according to the invention, of which FIG. 6A is a cross-sectional view of FIG. 6B along axis A2, FIG. 6B is an axial view along axis A1 of FIG. 1, and FIG. 6C is a perspective view in which the elements of the coupling are misaligned;

FIGS. 7A to C show a pair of the couplings connected together, in which FIG. 7A is a cross-sectional view with the elements of the couplings aligned, FIG. 7B shows the elements un-aligned, and FIG. 7C is an isometric view in which the elements are unaligned;

FIG. 8A to 8E show a further example of a coupling according to the invention, of which FIG. 8A is an axial view along axis A1 of FIG. 1, FIG. 8B is an isometric axial view showing the elements of the coupling un-aligned, FIG. 8C is a cross-sectional view along axis A3, FIG. 8D is a cross-sectional view along axis A2 and FIG. 8E is a side view of the coupling as shown in FIG. 8A;

FIGS. 9A to 9E show bearings in examples of couplings according to the invention, in which FIG. 9A is an axial view of an element of a coupling, FIG. 9B is a side view of the element of FIG. 9A, FIG. 9 C is a top view of the element of FIG. 9A, FIG. 9D is a cross sectional view of a coupling and FIG. 9E is an isometric view of a coupling;

FIG. 10 shows means for limiting relative rotation of elements of a coupling according to the invention;

FIG. 11 is a schematic diagram of a projection and slot useful in examples of couplings according to the invention;

FIG. 12A is a cross-sectional view of a modification of the couplings of the preceding drawings showing the elements un-aligned and FIG. 12B is an isometric view of the coupling of FIG. 12A;

FIGS. 13A to 13C show a yet further example coupling according to the invention, of which, FIG. 13A is an axial view along axis A1 of FIG. 1, FIG. 13B is a perspective view showing elements of the coupling un-aligned, and FIG. 13C is another isometric view showing elements of the coupling un-aligned;

FIGS. 14A to 14E show yet another example of a coupling according to the invention, of which FIG. 14A is a axial view along axis A1 of FIG. 1 with elements of the coupling un-aligned, FIG. 14B is an axial cross-sectional view along plane C-C of FIG. 14D, FIG. 14C is a cross-sectional view along plane A-A in FIG. 14A, FIG. 14D is a side view of the coupling of FIG. 14A, and FIG. 14E is an isometric view of the coupling;

FIGS. 15A and 15B show another example of a coupling according to the invention;

FIG. 16 shows an example of a coupling combining the use of projections and slots in part of the coupling and axles in another part, wherein FIGS. 16A, 16B, 16D are rear, front and side isometric views of the coupling with the members; and FIG. 16C is a cross sectional view of the coupling;

FIGS. 17A to 17D shows another example of a coupling according to the invention, in which FIG. 17A is an isometric front view of the coupling, FIG. 17B is an isometric rear view of the coupling, FIG. 17C is a cross-sectional view on axis A3 and FIG. 17D is an isometric side view.

FIG. 18 shows an end on view of a Spragg coupling according to the invention;

FIG. 19 shows a vertical section through the Spragg coupling of FIG. 18, the section being through the axis of the coupling;

FIG. 20 shows a section orthogonal to that in FIG. 19 again though the axis of the coupling;

FIG. 21 is a section through the Spragg rotor on a plane containing the spring wire 659 in FIGS. 19 and 20;

FIG. 22 is an exploded perspective view of the components of the Spragg coupling of FIGS. 18 to 21;

FIGS. 23A to 23C show an axial view (FIG. 23A) and vertical and horizontal sections (FIGS. 23B and 23C) of a coupling of the kind shown in FIG. 6 having seals;

FIG. 24 is an exploded view of the coupling of FIGS. 23A to 23C showing the individual components;

FIGS. 25A to 25C show detail of the inner annular member of the coupling of FIGS. 23A to 23C and 24, FIG. 25A being an end on axial view, FIG. 25B being a vertical section, and FIG. 25C a side view of the inner annular member;

FIGS. 26A and 26B show detail of the intermediate annular member of the coupling of FIGS. 23A to 23C and 24, FIG. 26A being an end on axial view, FIG. 26B being a vertical section;

FIG. 27 shows an end view of a further development of the coupling of FIGS. 23 to 26 with the seal support rings and seal removed but with further lubrication provision;

FIG. 28 is a vertical section on the line A-A of FIG. 27;

FIG. 29 is a section on the line C-C of FIG. 27;

FIG. 30 is a section on the line B-B of FIG. 27;

FIG. 31 is a side view of a coupling having the features of FIGS. 27 to 30 with grease nipples for the introduction of lubrication;

FIG. 32 is a section on the line P-P of FIG. 31 showing grease galleries;

FIG. 33 shows an end view of a coupling of FIGS. 27 to 32 with the cap and seal in place the invention and illustrating arrangements to relieve lubricant over-pressure;

FIG. 34 is a section on the line Q-Q of FIG. 33;

FIG. 35 is a section on the line R-R of FIG. 33;

FIG. 36 is an exploded view showing the components of the a coupling as illustrated in FIGS. 27 to 35;

FIGS. 37A, 37B, 37C and 37D illustrate in detail the centrifugal pump valve 154 shown in the coupling of FIGS. 27 to 36;

FIGS. 38 to 46 illustrate an further embodiment of the invention to that shown in FIGS. 23 to 37, in which:

FIG. 38 is an end on view of the alternative embodiment looking in the direction of arrow E of FIG. 39;

FIG. 39 is a side view of the alternative embodiment;

FIG. 40 is a vertical section of the embodiment in the line A-A of FIG. 38;

FIG. 41 is a perspective view of the embodiment;

FIG. 42 is a section in the line C-C of FIG. 39;

FIG. 43 is a section in figure B-B of FIG. 39;

FIG. 44 is a side view of the alternative embodiment with the drive shaft and output at an angle to one another;

FIG. 45 is a section in the line C-C of FIG. 44;

FIG. 46 is an exploded view of the coupling of FIGS. 39 to 48 showing the individual components;

FIGS. 47A to 47F show an example of the invention using alternative loading slot arrangements to those shown in FIG. 3, FIG. 47A is a orthogonal view of the coupling misaligned, FIG. 47B is a side vie of the coupling, FIG. 47C is a section of the coupling on vertical plane including axis A3 of FIG. 47A, FIG. 47D is a top view of the coupling, FIG. 47E is a section of the coupling on the axis A2 of FIG. 47A and FIG. 47F is a perspective view of the coupling; and

FIG. 48 shows an exploded view of the coupling of FIGS. 47A to 47F;

### DESCRIPTIONS OF EXAMPLES

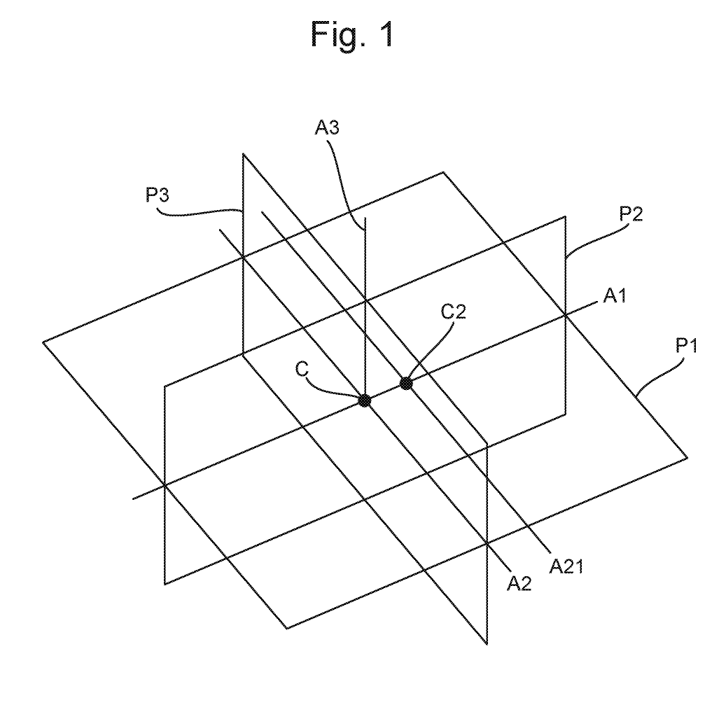

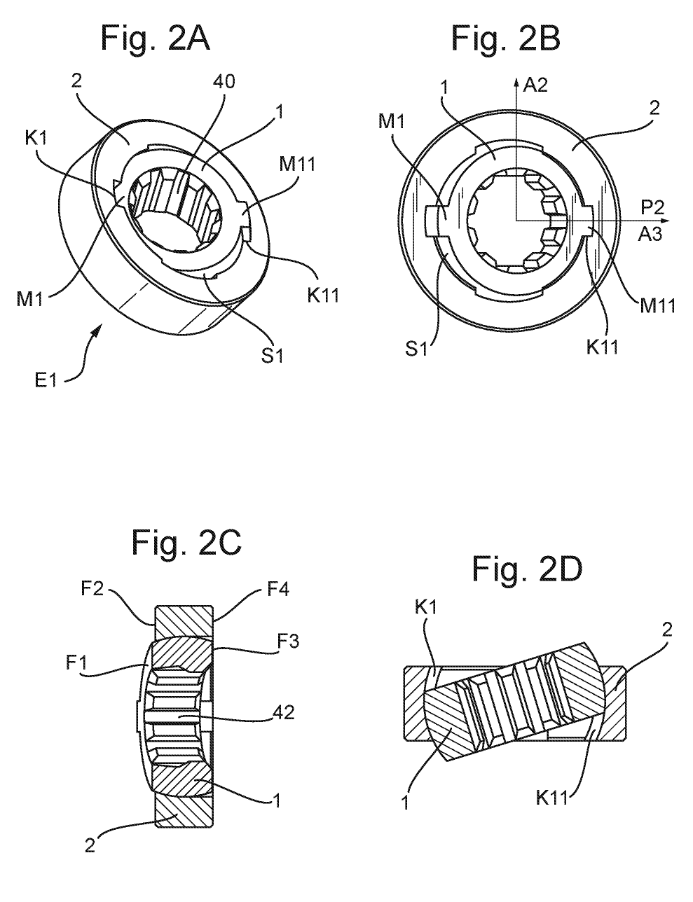

Examples of the invention in FIGS. 2 to 17 are described in relation to a reference frame as shown in FIG. 1.

The reference frame has a first axis A1 defining an axial direction. A second axis A2 is perpendicular to the first axis A1. At the intersection of the first and second axes is a central point C of concentric spherical surfaces of concentric members of the couplings. The first and second axes and the central point lie in first plane P1 and the first axis and central point lie in a second plane P2 perpendicular to the first plane. A third plane P3 trough the centre point C is perpendicular to the other planes. A third axis A3, perpendicular to axes A1 and A2, lies in the third plane and passes through the central point C.

The first axis A1 is a torsional axis on which for example, a drive shaft or driven shaft is connected to the coupling and the second A2 and third A3 axes are axes of relative rotation of members of the couplings.

In some examples, couplings have some members centred on the central point C and other members centred on a further central point C2 offset from C along the first axis A1 when the members are aligned. The offset of C2 from C may be slight, for example a fraction of a millimetre. Further axes A21 and A31, parallel to axes A2 and A3, respectively pass through the central point C2.

In FIG. 2, a coupling comprises a pair of members 1 and 2, an inner annular member 1 and an outer annular member 2 each comprising spherical segments. The inner annular member 1, around axis A1, is centred on the central point C which is on that axis and has an outer peripheral surface S1 which is convexly spherical and centred on the central point C. The inner annular member 1 has a central aperture 40 which in this example has splines 42 for engaging a correspondingly splined shaft.

An outer annular member 2 has an inner peripheral concave spherical surface S21 which is complementary to the convex outer surface S1 of the inner member 1. The concave spherical surface S21 is centred on the same central point C. The inner spherical surface S21 of the outer member 2 and the outer spherical surface S1 of the inner member 1 are contiguous plain bearing surfaces.

Elongate projections M1 and M11 extend radially of the central point C, and parallel to the first axis A1, from the convex spherical surface S1 of the inner member 1. The outer surfaces of the projections also extend parallel to the spherical surface S1. The projections extend into complementary slots K1 and K11 in the inner concave surface S21 of the outer annular member 2. The projections and slots constrain the inner and outer annular members to be rotatable, one relative to the other, about the second axis A2 of rotation through the central point and perpendicular to the first axis. Projection M11 and slot K11 are identical to and diametrically opposite projection M1 and slot K1 respectively. The coupling will work without projection M11 and slot K11, but it is less robust against failure.

The central point C of the adjacent convex and concave spherical surfaces S1, S21, lies between the axial facing faces F1 and F3 of the inner member 1 and between the outer faces F2 and F4 of the outer member 2. As a result of that, the periphery of the inner convex spherical surface mid-way between the axially facing faces F1 and F3 is at a greater radius than the periphery of the concave surface of the outer member 2 at the axially facing faces thereof F2 and F4. Thus the inner annular member is retained axially in the outer annular member over the operational range of rotation of the outer member 2 about the second axis.

In the examples E1 shown in FIG. 2 there are splines 42 in the central bore of inner member 1 for engaging a shaft. Splines (not shown) may additionally or alternatively be provided on the outer periphery of the outer member 2 for engaging another shaft. The coupling may be allowed to slide relative to the shaft(s) providing an axial degree of freedom.

In the example shown the projections M1, M11 which fit into associated slots K1, K11 with minimal clearance between the sides of the projections and the sides of the slots. However, in another example one of the projections projects into its associated slot with a predetermined substantial clearance between the sides of the projection and the sides of the slot to act as a back-up if the other projection, which fits into its associated slot with minimal clearance, fails.

The inner 1 and outer 2 members are both annular in FIG. 2. Each is a section of a sphere centred on the central point C at the intersection of the first A1 and second A2 axes.

As shown in FIG. 2A to 2D, the projection(s) project(s) from the inner annular member 1 into slot(s) in the outer member 2. However the projection(s) may project from the outer member into slot(s) in the inner annular member 1.

In FIG. 2, the spherical surfaces bear loads acting radially of the axis and in the direction of the axis. The projection and slot transmit torque about the first axis between the inner and outer members. The inner member 1 and outer member 2 comprise spherical segments.

In one use of the coupling, rotation of the shaft about the first axis is transmitted from the inner member 1 by the projections M1 and M11 and slots K1 and K11 to the outer member 2 which also rotates. The outer member may be connected to another shaft. In another use, one of the members, e.g. the outer member is fixed and static torque is transmitted from the inner member to the outer member.

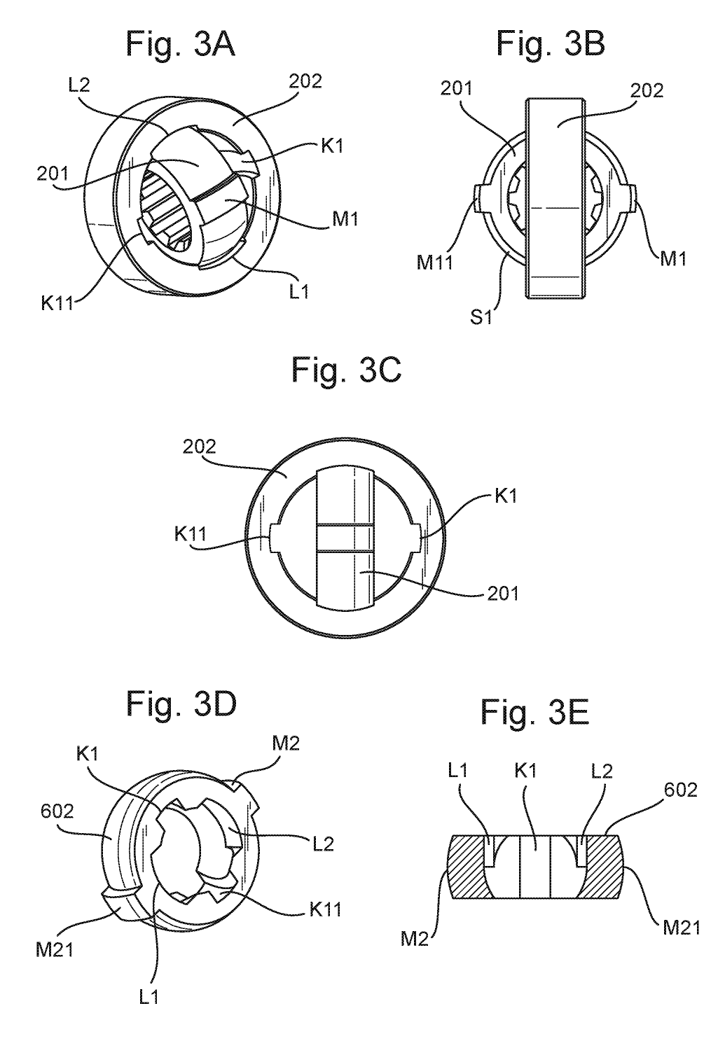

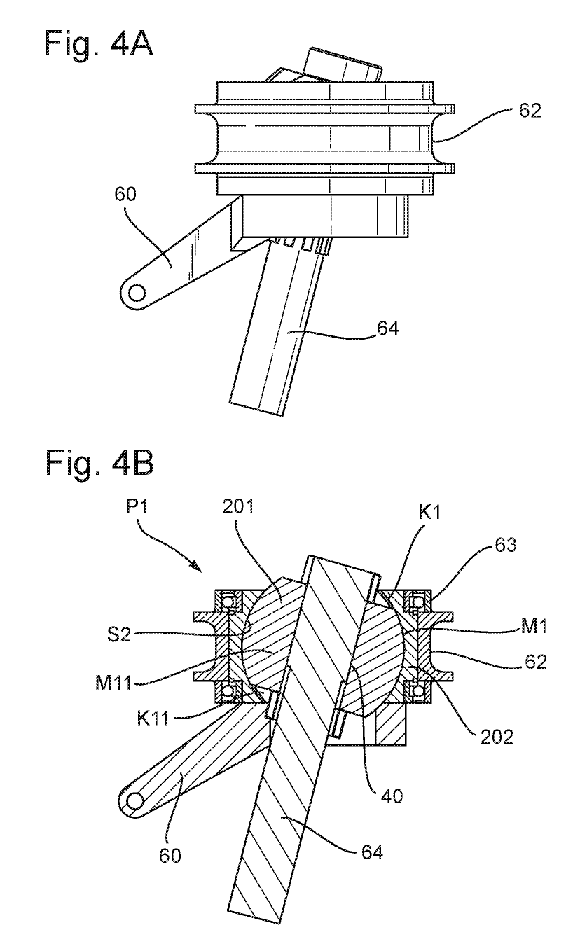

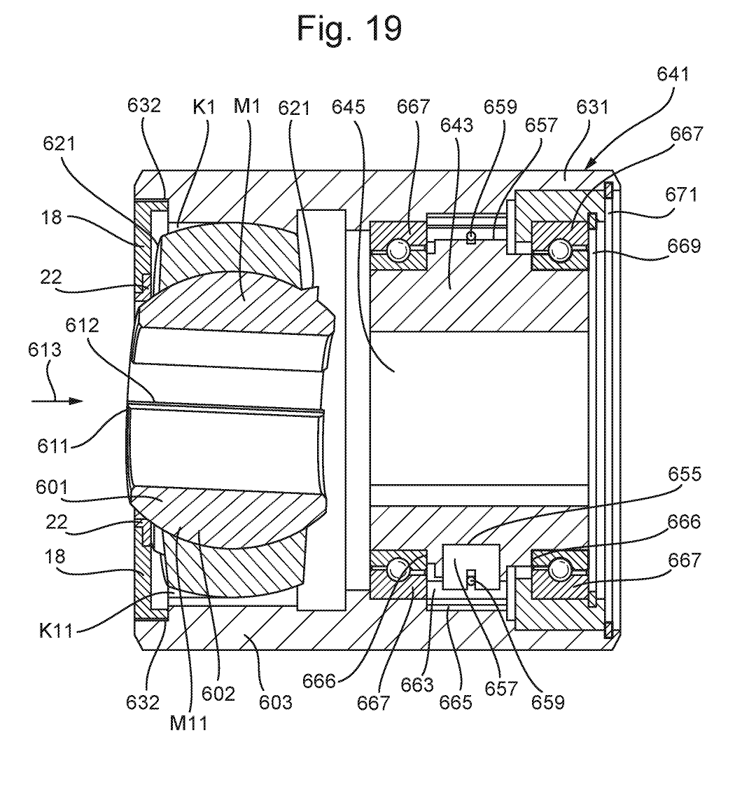

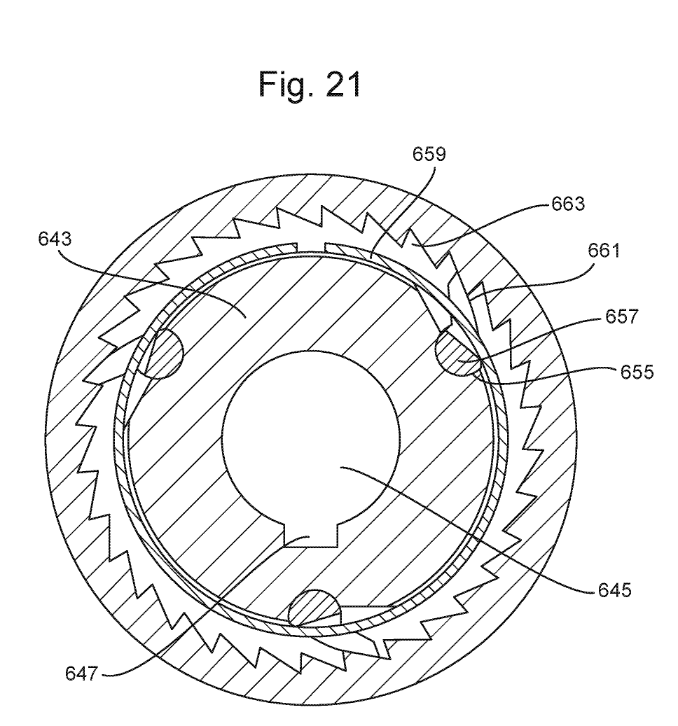

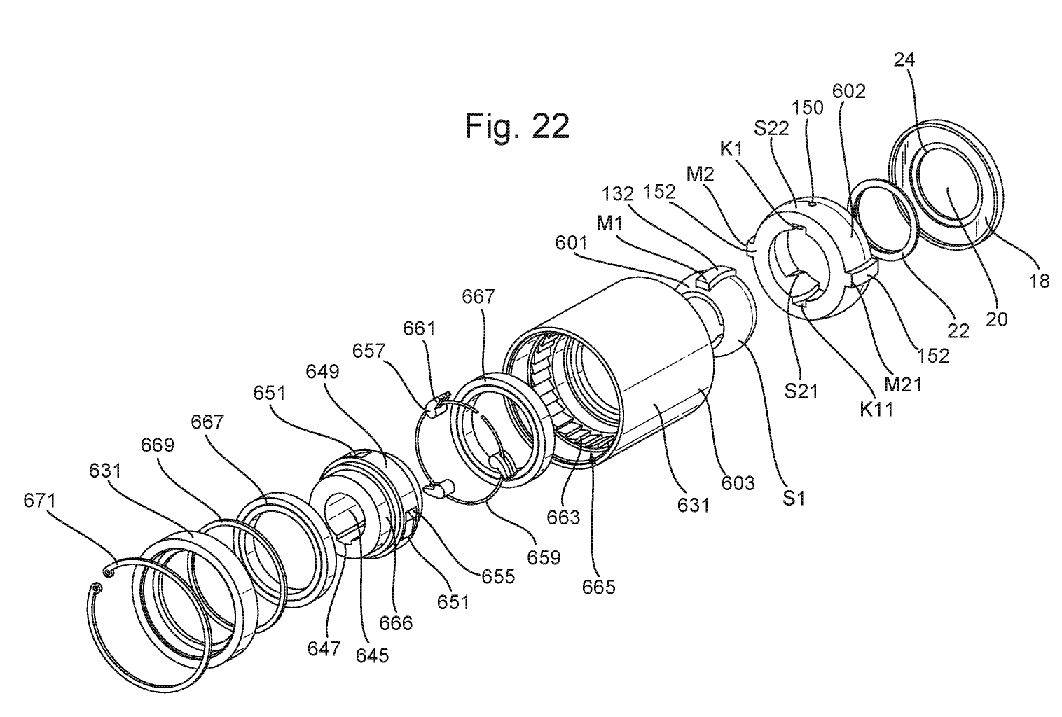

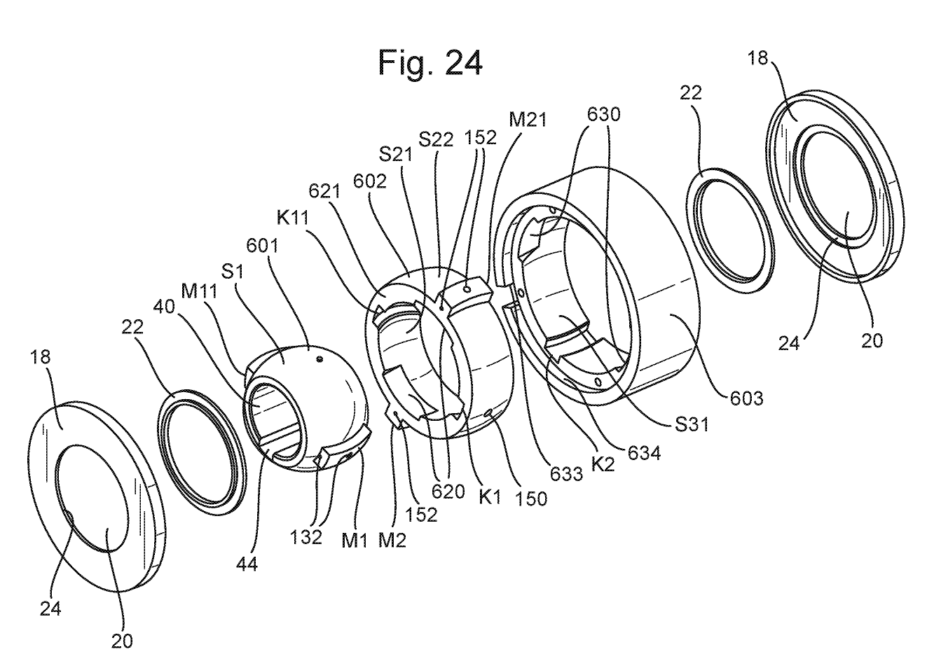

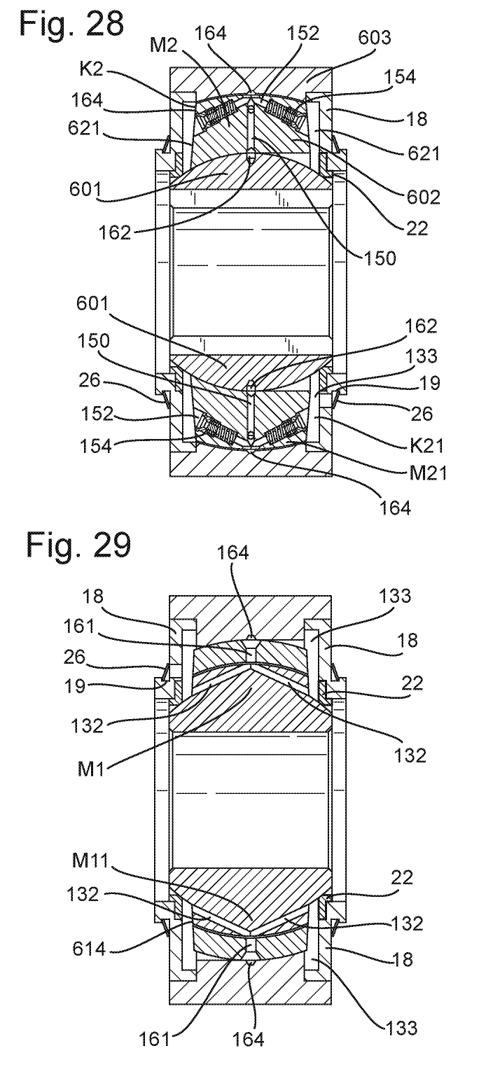

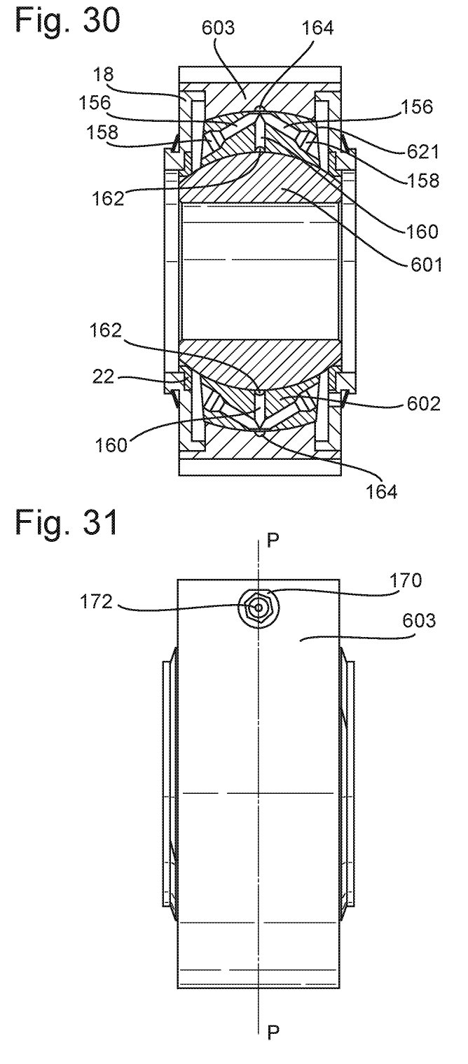

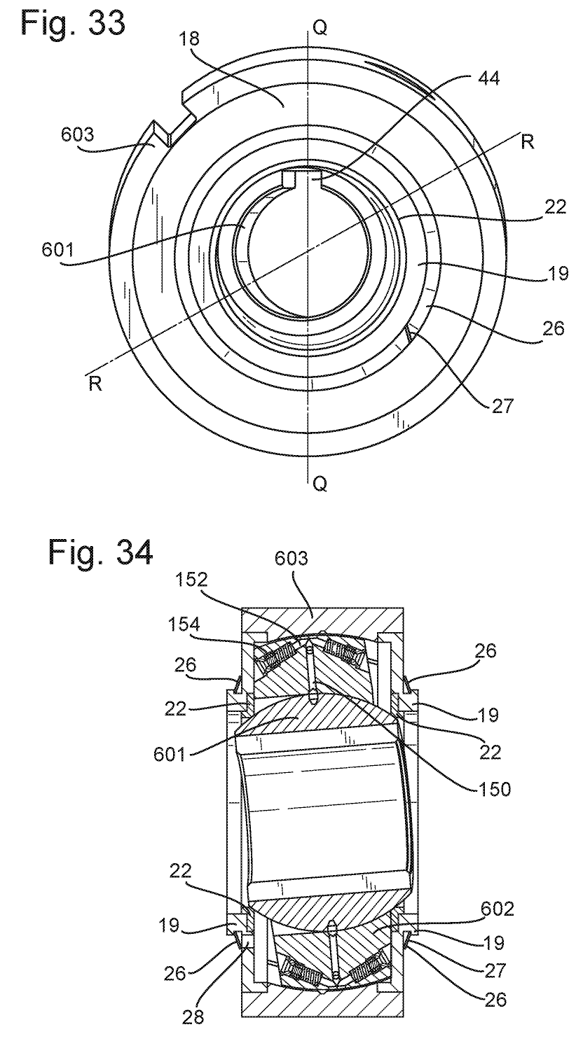

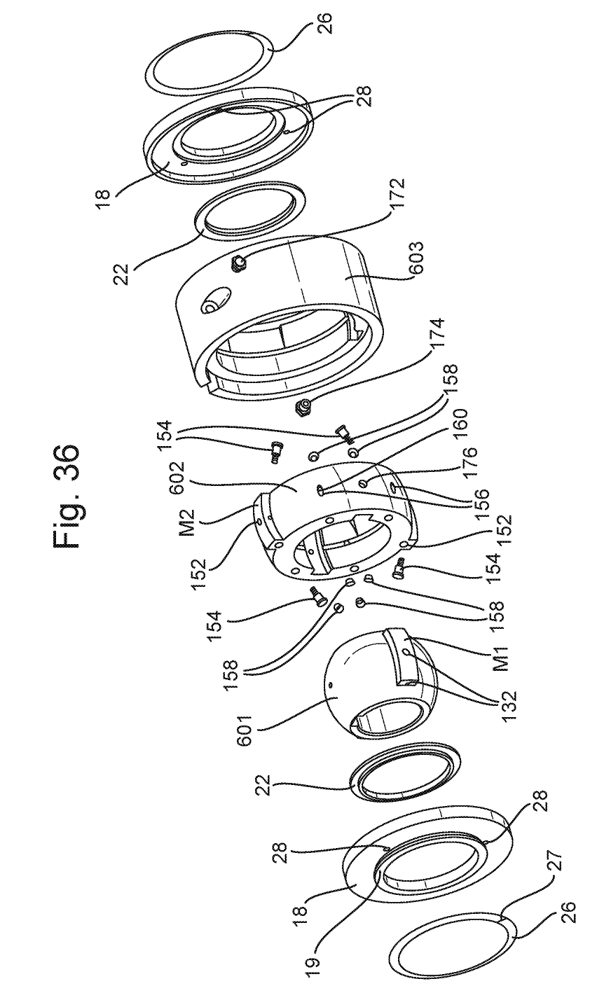

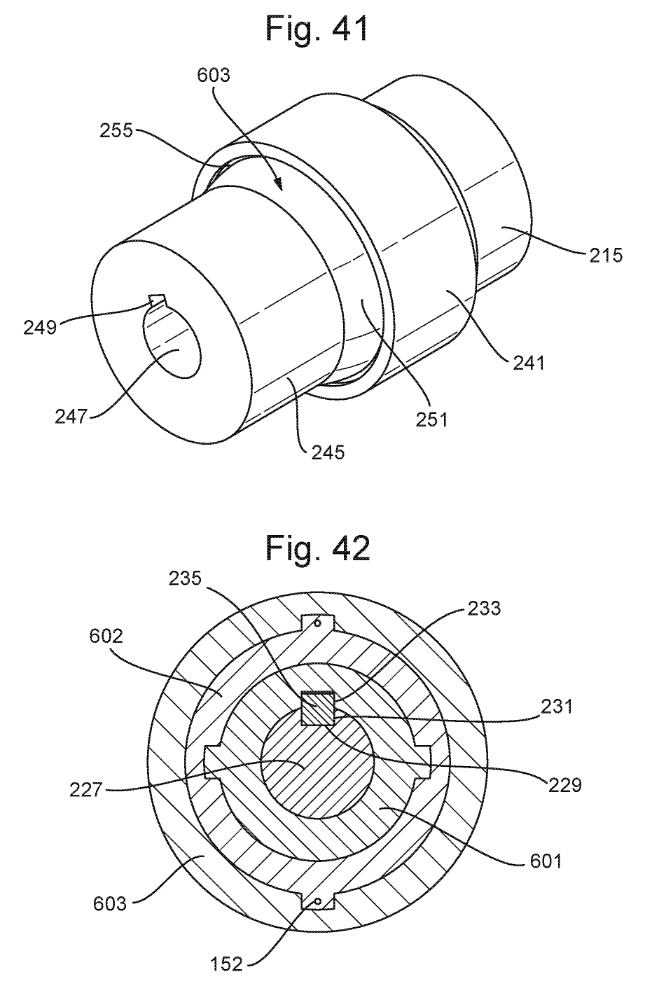

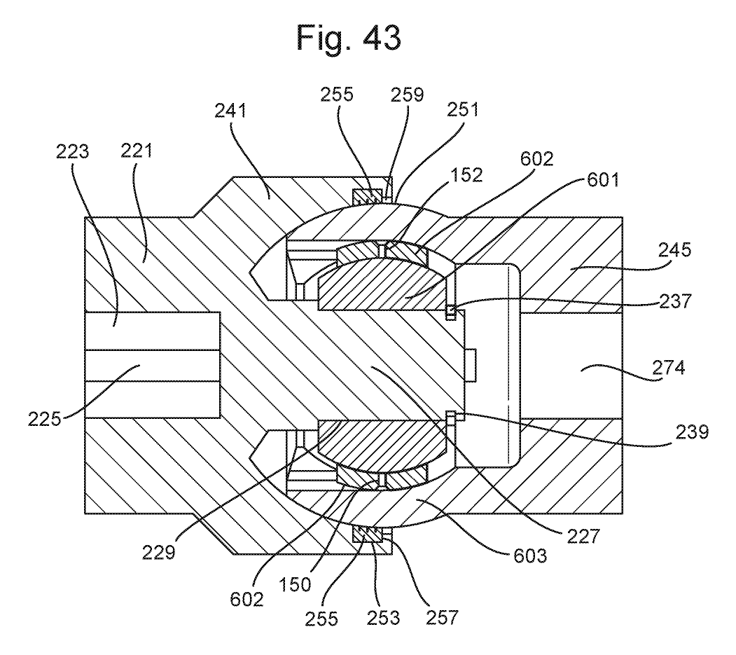

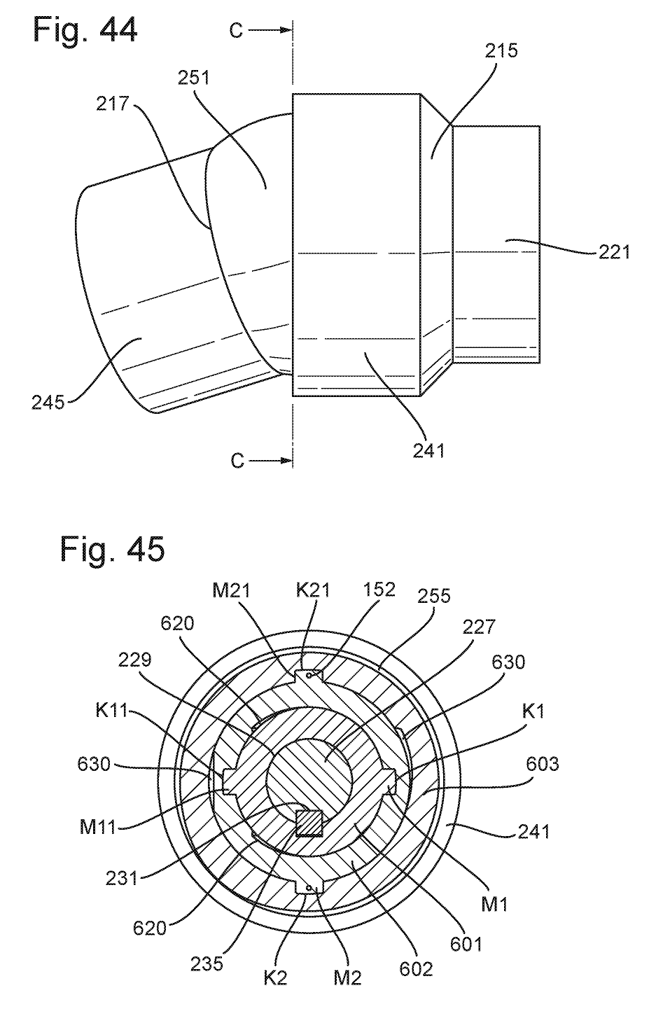

FIGS. 3A to 3E illustrate how the coupling in FIG. 2 is assembled. The same method is used in all the other couplings illustrated in FIGS. 4 to 48 below. The outer member 202 has two, diametrically opposite loading slots L1 and L2. As shown in FIG. 3E, the slots extend halfway across the width of the outer member. The slots are dimensioned so that the diametrically opposite floors of the slots are spaced by the diameter of the outer surface S1 of the inner member 201. The width of each slot is equal to or slightly greater than the width of the inner member. The inner member 201 is introduced sideways into the slots as shown in FIGS. 3A, 3B and 3C with its projection(s) M1, M11 aligned with the slot(s) K1, K11 and then rotated so the projection(s) enter(s) the slot(s).

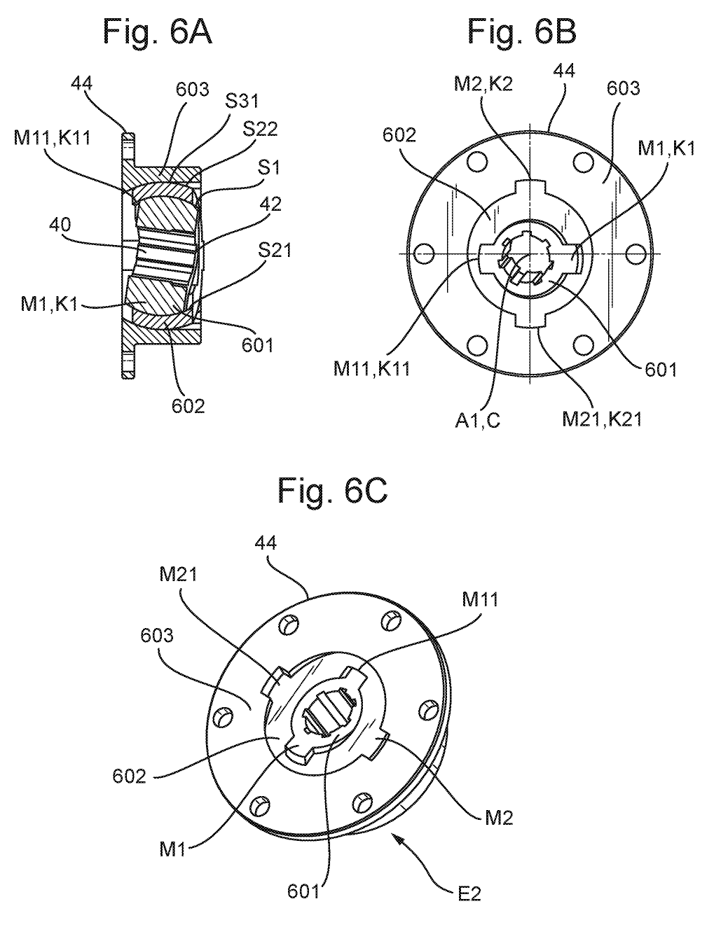

Other couplings described below have two or more annular members around the inner member concentric rings. Each pair of annular members may be assembled as described with reference to FIG. 3. It will be noted that FIGS. 3D and 3E show an annular member 602 of, for example, the embodiment of FIG. 6A to 6C which has two annular members around the inner member, intermediate annular member 602 fitting within the outermost annular member 603.

The assembly method of FIG. 3 provides a robust, strong, coupling. It enables the individual members to be machined from solid material and minimises the risk of failure as a result of joining two halves of members together. The method described enables all the bearing surfaces described in this specification to be continuous i.e. avoiding any joins (and thus weak areas) at the join of a member assembled in two halves bolted or welded together.

One possible use of the coupling of FIG. 2 is in a hub centre steering mechanism of a vehicle. In FIG. 4 a steered wheel hub 62 is supported by a support member 64 which in this example is a suspension arm.

The coupling P1 couples the suspension arm 64 to the steered wheel hub 62. The arm 64 is engaged by splines 42, in the central aperture 40 of the first inner annular member 201 of the coupling. The projection(s) M1, M11 and slot(s) K1, K11 allow the outer member 202 to rotate about one axis (the steering axis) relative to the first inner annular member 201 and arm 64. The outer member 202 supports the wheel 62 which is free to rotate on bearings 63. A steering arm 60 is fixed to the outer annular member 202 to rotate it relative to the first inner annular member and shaft 64.

In this example the projection(s) M1, M11 and slot(s) K1, K11 provide support to allow relative rotation but do not drive the wheel hub 62.

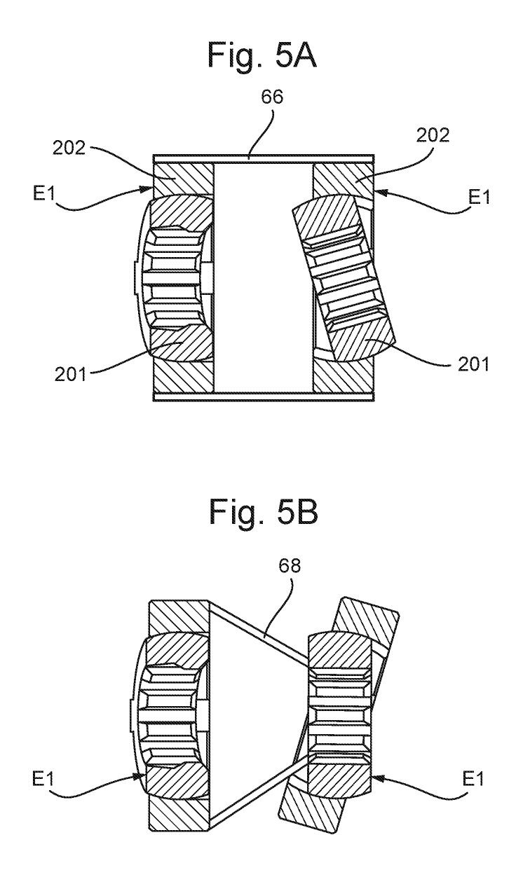

FIG. 5A shows a coupling arrangement comprising two couplings as shown in FIG. 2 connected together by a connecting structure 66. The structure 66 rigidly connects the two couplings. In FIG. 5A it connects the outer member 202 of the couplings. The projections of the two couplings are orthogonal relative to each other, but could be non-orthogonal. In the example of FIG. 5A the connecting structure is a tube coupling the outer members. In a modification of FIG. 6A, one of the couplings is fixed in the tube and the other is free to move axially within the tube.

In another example, shown in FIG. 5B, the outer member 202 of one coupling is connected to the inner member 201 of the other by a connecting structure shown schematically at 68.

One illustrative use of such a coupling is a crank handle. If the projections of the two couplings are in the same orientation. In other examples the projection(s) of one coupling are orthogonal to the projection(s) of the other.

In FIGS. 6A to 6C, a coupling comprises a first, inner annular member 601, annular intermediate member 602 and an annular outermost member 603. Each of the members 601, 602, 603 comprises spherical segments about the centre C. The inner annular member 601 is centred on a first axis A1, the inner annular member 601 having an outer peripheral surface S1 which is convexly spherical centred on the point C on the axis A1. The first inner annular member 601 has a central bore 40 which in this example has splines 42 for engaging a correspondingly splined shaft.

The intermediate annular member 602 has an inner peripheral surface S21 which is concavely spherical complementary to the outer surface S1 of the first inner member 601. In this example the inner spherical surface S21 of the intermediate member 602 and the outer spherical surface S1 of the first inner member 601 are contiguous plain bearing surfaces.

Diametrically opposite elongate projections M1 and M11 extends radially of, and parallel to, the first axis A1 from the convex spherical surface S1 of the inner member 601. The outer surface of the projection also extends parallel to the spherical surface S1. The projections extend into complementary slots K1 and K11 in the inner concave surface S21 of the intermediate member 602. The projections M1, M11 and slots K1 K11 constrain the first inner 601 and intermediate member 602 members to be rotatable one relative to the other about the second axis A2 of rotation through and perpendicular to the first axis A1.

The intermediate member 602 has an outer periphery S22 which is convexly spherical. The outermost annular member 603 has an inner peripheral surface S31 which is concavely spherical complementary to the outer surface S22 of the intermediate member 602. In this example the inner spherical surface S31 of the outermost member and the outer spherical surface S22 of the intermediate member 602 are contiguous plain bearing surfaces.

Second elongate projections M2 and M22 extend radially of, and parallel to, the first axis from the convex spherical surface S22 of the intermediate member 602. The outer surface of the second projections M2 and M22 also extends parallel to the spherical surface.

The projections M2 and M21 extend into complementary, second, slots K2 and K21 in the inner concave surface of the outermost member 603. The second projection M2 and M21 and second slots K2 and K21 are perpendicular to the first projections M1, M11, and first slots K1, K11. They constrain the intermediate 602 and outermost 603 members to be rotatable one relative to the other about the third axis A3 of rotation (see FIG. 1) through the centre point C, and perpendicular to both the first axis A1 and second axis A2.

The inner member 601 is retained in the intermediate member 602, and the intermediate member 602 is retained in the outermost member 603.

In this example the second projections M2 and M21 and corresponding slots K2 and K21 could be omitted but with less security in the event of failure.

One use of the couplings of FIG. 6 is as a universal joint as it allows angular misalignment of the shafts by virtue of the relative rotation of the inner and outermost members about the second axis.

The coupling of FIG. 6 has a flange 44, fixed to or integral with the third annular member for connecting the third annular member to a structural element, for example a shaft. The flange 44 may be replaced by splines or some other connecting means.

The projections M1, M11 and M2 M21 may be in intermediate member 602 and outermost member 603 respectively projecting into slots K1, K11, K2, K21 in inner member 601 and intermediate member 602.

The pairs of members 601 and 602, and 602 and 603 each comprise a pair of members within the meaning the claims below.

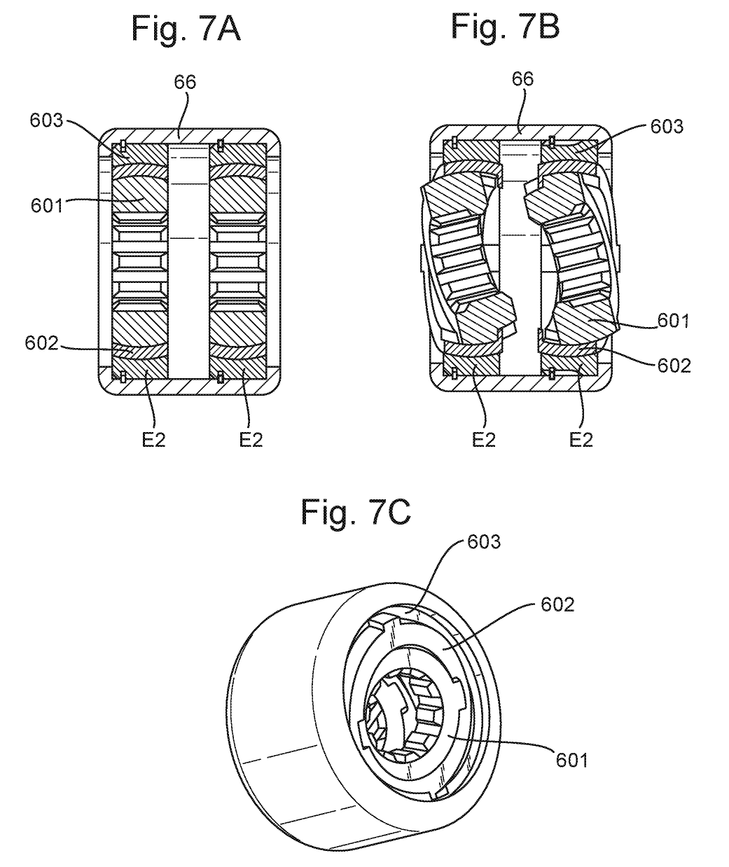

FIG. 7 shows a coupling arrangement comprising two couplings E2 of the kind shown in FIG. 6 (without the flange 44) connected together by a connecting structure 66. The structure rigidly connects the two couplings.

In FIG. 7 it connects the outermost members 603 of the couplings. In the example of FIG. 7 the connecting structure is a tube coupling the outer members. One illustrative use of the coupling of FIG. 7 is as an approximation to a double Cardin shaft arrangement, if the projection or projections of one of the couplings are non-orthogonal to those of the other. One of the couplings E2 may be free to move axially in the tube 66.

The projections M1, M11, M2, and M21 of one coupling may be orthogonal to those of the other or preferably parallel to those of the other in further examples depending on the application.

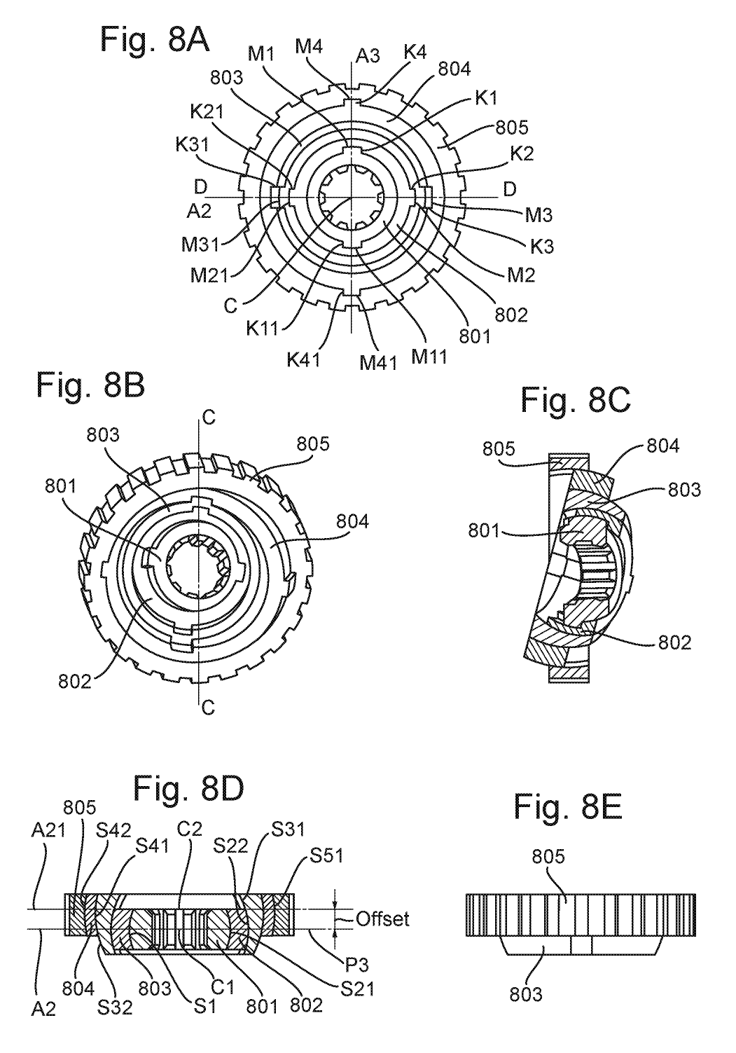

In FIGS. 8A to 8E the coupling comprises an inner, annular member 801 centred on the central point C on the first axis A1, first, second and third intermediate annular members 802, 803, and 804, and outer annular member 805. The members 801 and 802 and their spherical bearing surfaces are concentric about central point C. The members 804 and 805 and their spherical bearing surfaces are concentric about a central point C2 offset along axis A1 as described in the reference frame of FIG. 1 the second intermediate member 803 has its inner spherical surface centred on C and its outer spherical surface centred on C2.

The inner annular member 801 has an outer peripheral surface S1 which is convexly spherical centred on the central point C on the first axis A1. The inner annular member 801 has a central aperture which has splines for engaging a correspondingly splined shaft.

A first intermediate member 802 has an inner peripheral surface S21 which is concavely spherical complementary to the outer surface S1 of the first annular member 801. In this example the inner spherical surface S21 of the annular member 802 and the outer spherical surface S1 of the first annular member 801 are contiguous plain bearing surfaces.

Diametrically opposed elongate projections M1 and M11 extend radially of, and parallel to, the first axis A1 from the convex spherical surface S1 of the inner ring 801. The outer surface of the projections M1 and M11 also extends parallel to the spherical surface S1. The projections extend into complementary first slots K1 and K11 in the inner concave surface S21 of first intermediate annular member 802. The first projections and first slots constrain the pair of members comprising the inner member 801 and first intermediate annular member 802 to be rotatable one relative to the other about second axis A2 perpendicular to the first axis A1.

The first intermediate annular member 802 has an outer periphery S22 which is convexly spherical. A second intermediate annular member 803 has an inner peripheral surface S31 which is concavely spherical complementary to the outer surface S22 of the first intermediate annular member 802. In this example the inner spherical surface S31 of the second intermediate member 803 and the outer spherical surface S22 of the first intermediate annular member 802 are contiguous, plain, bearing surfaces.

Second elongate projections M2 and M21 extends radially of, and parallel to, the first axis A1 from the convex spherical surface S22 of the first intermediate member 802. The outer surface of the second projections M2 and M21 also extend parallel to the spherical surface S22. The projections extends into a complementary, second, slots K2 and K21 in the inner concave surface S31 of the second intermediate member 803. The second projections M2 and M21 and second slots K2 and K21 are perpendicular to the first projections M1, M11 and first slots K1 and K11. They constrain the pair of members comprising the first intermediate annular member 802 and the second intermediate annular member 803 to be rotatable one relative to the other about third axis A3 through the central point C, and perpendicular to the first and axes A1 and A2.

The second intermediate annular member 803 has an outer periphery S32 which is convexly spherical. A third intermediate annular member 804 has an inner peripheral surface S41 which is concavely spherical complementary to the outer surface S32 of the second intermediate annular member 803. In this example the inner spherical surface S41 of the third intermediate annular member 804 and the outer spherical surface S32 of the second intermediate annular member 803 are contiguous, plain, bearing surfaces.

Third elongate projections M3 and M31 extends radially of, and parallel to, the first axis A1 from the convex spherical surface S32 of the second intermediate annular member 803. The outer surface of the projections M3 and M31 also extends parallel to the spherical surface S32. The projections M3 and M31 extends into a complementary, third, slots K3 and K31 in the inner concave surface of the third intermediate annular member 804. The third projections M3 and M31 and third slots K3 are K31 are in the same plane as projections M2 and M21, and slots K2 and K21 of and thus constrain the pair of members comprising the second intermediate member 803 and third intermediate member 804 o be rotatable one relative to the other about axis A31 parallel to axis A3. The it will be seen that the second intermediate annular member 803 differs from the other annular members in that its internal slots K2 and K21 co-operating with projections M2 and M21 of the first intermediate annular member 802 is in the same plane as its projections M3 and M31.

The third intermediate annular member 804 has an outer periphery S42 which is convexly spherical. A concavely spherical complementary to the outer surface S42 of the third annular member 804. In this example the inner spherical surface S51 of an outermost annular member 805 and the outer spherical surface S42 of the third intermediate annular 804 are contiguous, plain, bearing surfaces. Fourth elongate projections M4 and M41 extend radially of, and parallel to, the first axis A1 from the convex spherical surface S42 of the third annular member 804.

The outer surface of the fourth projections M4 and M41 also extend parallel to the spherical surface. The projections extends into a complementary, fourth, slots K4 and K41 in the inner concave surface S51 of the outermost member 805. The fourth projections M4 and M41 and fourth slots K4 and K41 are perpendicular to the third projections M3, M31, and third slots K3, K31. They constrain the pair of members comprising the third intermediate annular member 804 and the outermost member 805 to be rotatable one relative to the other about axis A21 parallel to axis A2 as shown in FIG. 8D. The further axis A21 is through and perpendicular to the first axis because the fourth projection M4, M41 and fourth slots K4, K41 are parallel to the first projections M1, M11 and first slots K1 and K11.

The members are assembled and retained in the coupling in the same way as described with reference to FIG. 3.

As in previous examples projections M11, M21, M31 and M41 and corresponding slots K11, K21. K31 and K41 could be omitted but with less security in the event of failure.

In the examples of FIG. 8, it has been found that the third intermediate member and outermost members should be offset relative to the first and second members along the axis A1. This may be achieved by offsetting the outer spherical surface S32 of the second intermediate member 803 axially of the inner spherical surface S31 of the second intermediate member 803 as shown in FIG. 8D.

One illustrative use of the coupling of FIG. 8 is as an approximation to a constant velocity joint or double Cardan joint. In one double Cardan design the inner annular member 801 would be configured to move in the horizontal plane, the first intermediate annular member 802 would be configured to move in the vertical plane, the second intermediate annular member 803 would be configured to move in the vertical plane (but has the offset) and the third intermediate 804 would be configured to move in the horizontal plane. In another design, the inner annular member 801 is configured to move in a vertical plane, the first intermediate member 802 in a horizontal plane and so-on.

The projections may be in outer annular members projecting into slots in inner annular members in the examples of FIG. 8.

The pairs of members 801 and 802, 802 and 803, 803 and 804, and 804 and 805 each comprise a pair of members within the meaning of the claims below.

Members 801 and 802 comprise spherical segments about the centre C. Members 803, 804 and 805 comprise spherical segments about the centre C2. However, the central aperture of second intermediate member 803 is a spherical segment centred on centre C.

In the examples of FIGS. 2 to 8, the spherical surfaces are all contiguous, plain, bearing surfaces. Ball barrel roller or other rotational bearings may be provided between the adjacent spherical surfaces of a pair of annular members.

Rolling element bearings may be provided on the projections.

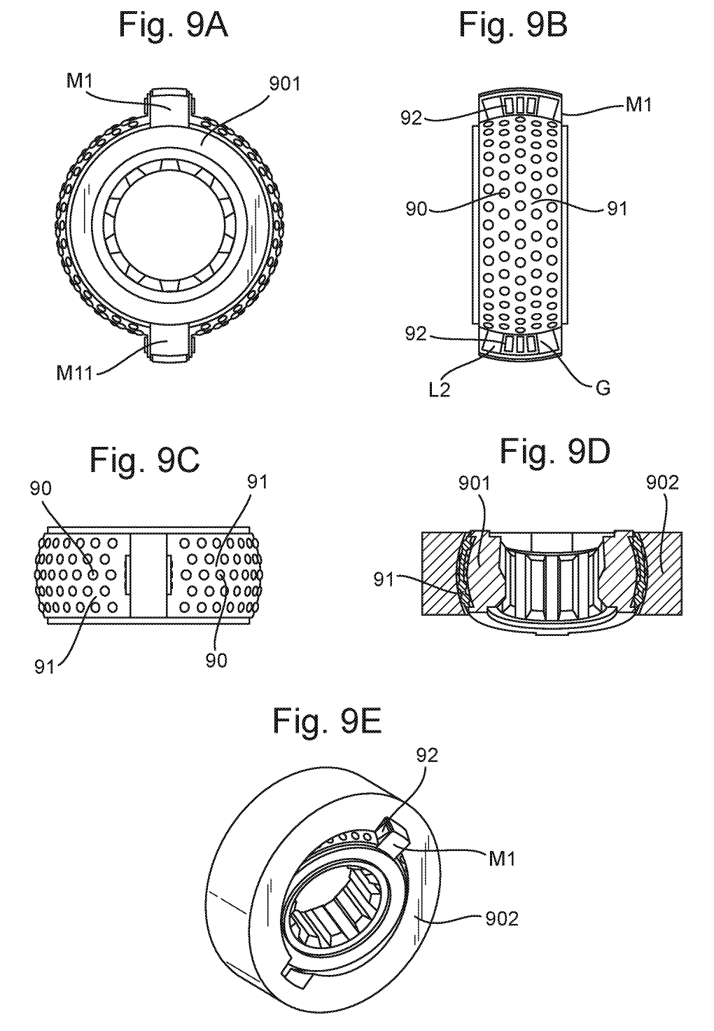

Referring to FIGS. 9A, B and C rolling element bearings in the form of ball bearings 90 held in cages 91 are provided between the inner member 901 of the pair of members 901 and 902. As an alternative or in addition ball bearings 92 held in cages G are provided in recesses 12 in the sides of the projections M1 and M2.

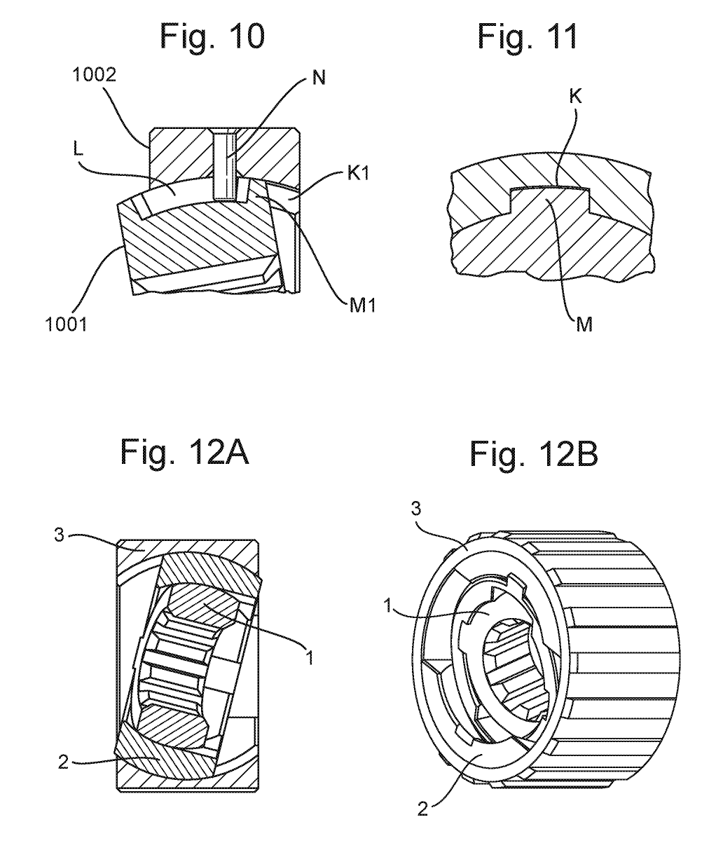

Turning to FIG. 10, as discussed the spherical surfaces of pairs of adjacent members co-operate to bear radial and axial loads. To ensure that the coupling can bear a desired axial and radial load the spherical surfaces need to overlap sufficiently. Thus means may be provided to limit the relative rotation of pairs of adjacent members. Such limiting means also assists the retention of each inner annular member in its associated outer annular member. In FIG. 10 the limiting means may comprise a fixed pin N projecting from an outer member 1002 of a pair of members, 1001 and 1002 into a groove L in an adjacent member, in this example in a projection M1 of the inner annular member 1 of the pair of members. Other examples of such limiting means include a stop within the coupling and a support structure which limits movement.

FIG. 11 shows the forms of projections, M1, M2 . . . etc. A projection M projects into a slot K. As shown schematically in FIG. 11, preferably the radially outer surface of the projection is spaced from the radial outer end of the slot to avoid or at least reduce radial loading on the projection.

The projections and slots of any of the examples of the invention may have an involute or pseudo-involute shape. The outer end of the projection M may be spaced from the inner face of the slot K to reduce radial loading on the projection and slot.

The purpose of the involute shape is to improve/reduce bearing pressure distribution on and stress distribution in the projection, as with involute splines.

In FIG. 11, the ends of the outer ends of the projections M1, M2 . . . etc are shown as being of a part cylindrical profile in cross section, they can have a flat profile in cross section. Normally, lengthways, they are contoured to be concentric with the annular member with which they are associated. However, if the projections and associated slots are sufficiently deep and sufficient clearance allowed between the outer ends of the projections and the bases of the slots, the surfaces can be spherical, cylindrical or flat (straight through).

As shown in FIG. 12, to increase the operational range of relative rotation, the outer one 2, or 3 of two adjacent pairs of members 1 and 2 or 2 and 3 may be larger in the axial direction A1 than the inner one 1 or 2. FIG. 12 shows three annular members 1, 2 and 3. The principle of FIG. 12 may be applied to any of the pairs of annular members of the examples of the invention. In other words the angle subtended at the centre by the inner spherical concave periphery of the outer member 2 or 3 is greater than the angle subtended at the centre by the outer spherical convex periphery of the inner member 1 or 2 as appropriate.

In all of the examples described above with reference to FIGS. 1 to 12, each projection M and associated slot K defines a radial plane P2 and or P3 coincident with the first axis A1 in which the adjacent members coupled thereby are constrained to rotate one relative to the other about an axis A2, A3, A21, or A31. It will be noted that in the examples described above the projections and slots all project radially of the central point C or C2 on the axis A1.

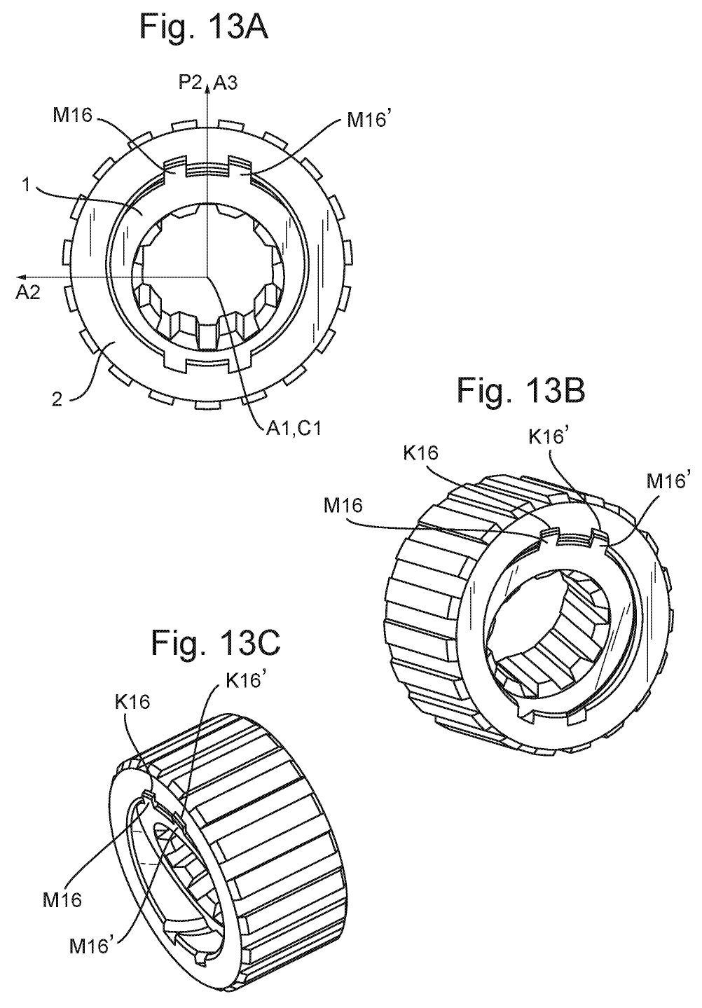

As shown in FIG. 13, each single projection and associated slot in adjacent pairs of members (shown in FIG. 13 as 1 and 2) of the examples described above may be replaced by two (or more) parallel, spaced apart, projections and slots. In the example shown in FIG. 13 each single projection and slot is replaced by two projections M16, M16′ and slots K16, K16′, one projection and slot being each side of, and equidistant from, the said radial plane P of relative rotation. In the example of FIG. 13 the projections and slots are each side of and equidistant from the plane P2.

In other examples each radially extending single projection and associated slot of the examples describe above may be replaced by a single projection and slot in a plane offset from and parallel to radial plane through the radially extending projection and slot.

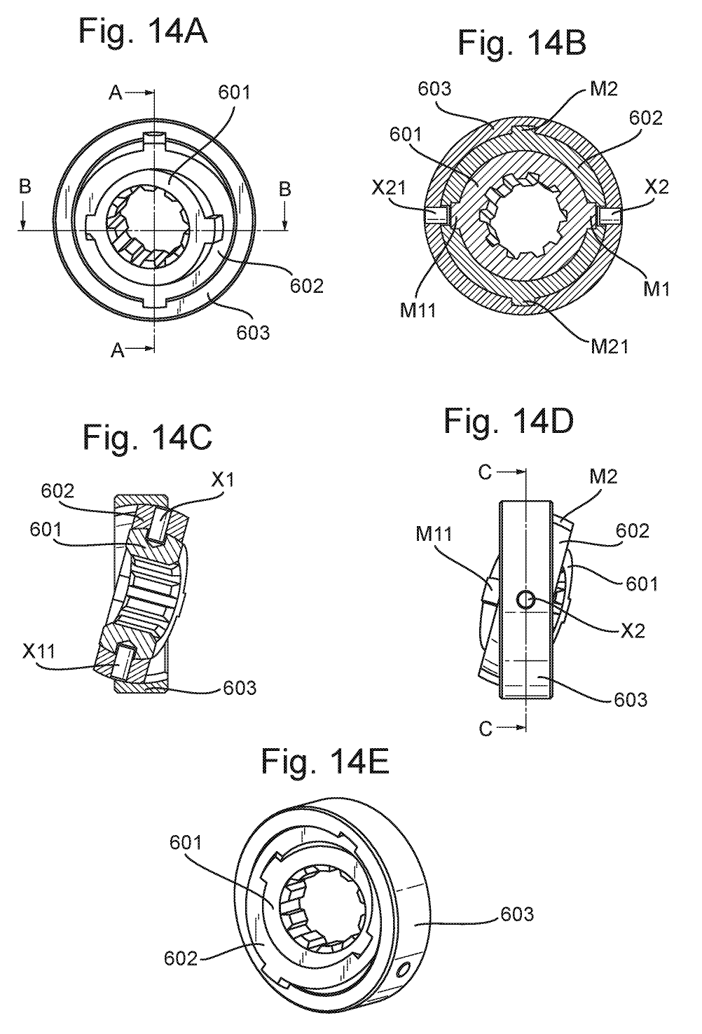

FIG. 14 shows an important embodiment of the invention for use in highly safety critical applications, such as found in the aircraft industry. In FIG. 14 axles X are be provided in addition to the projections M and slots K for coupling adjacent members. FIG. 14 shows a modification of the coupling of FIG. 6 in which axles X2, X21, and X1, X11 are provided on the axes A2 and A3 respectively, defined by the projections M1, M11, M2, M21 and slots K1, K11, K2, K21, of relative rotation of the adjacent pairs of members 601 and 602 and 602 and 603. The axles joining adjacent members may comprise two diametrically opposed shafts fixed at one end to the outer of the two members and projecting into a bore in the outer surface of the inner one of the two members. Each such shaft acts as a plain bearing in the inner one of the two members. A ball roller or other rotational bearing may be provided around the shaft in the inner one of a pair of members.

The axles X have clearance around their bores in the inner of the pair of annular members. For example in FIG. 14B axles X2 and X21 have clearance within their bores in annular member 602, nor do their bases touch the projections M1 and M11. Similarly axles X1 and X11 have no contact with inner annular member 601 in FIG. 14C. As a result, normally torsional loads are transmitted between the members 601, 602, 603 through the projections and slots M1, M2 . . . etc. K1, K2 . . . etc. If a projection say M1 fails, projection M11 provides sufficient redundancy to enable normal operation. However if projection M11 also fails, then axles X1 and X11 can replace them in transmitting torsional loads. Even then there is further redundancy as the coupling can continue operation even if one of the axles X1 and X11 fails. This redundancy provides sufficient continuity of safe operation to enable the failures to be identified in normal maintenance, and the coupling replaced.

In the preceding paragraph, the coupling is designed so that torsional loads will normally be transmitted by the projections and slots. By designing narrow projections (or wider slots), and reducing the clearance around the axles, the position can be reversed with the axles normally bearing the loads and the projections and slots acting as back-up in the event of failure.

Axles may be provided in addition to the projections and slots on some but not all pairs of members in examples where there are a plurality of pairs of members as in FIGS. 6 and 8 For example, the axles may only be provided in addition to the projections and slots on the inner most pair of members i.e. members 601 and 602 in FIGS. 6 and 801 and 802 in FIG. 8.

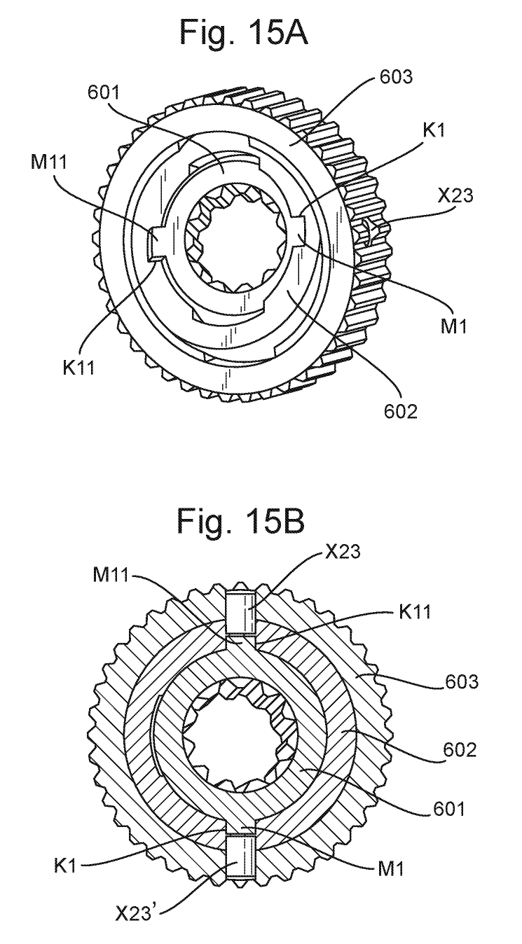

FIG. 15 shows another modification of the coupling shown in FIG. 6. In FIG. 15, the inner member 601 has diametrically opposite radially projecting projections M1 and M11 projecting from the outer spherical surface into complementary slots K1 and K11 in the inner spherical surface of the intermediate member 602. The projections constrain the first and second members to be relatively rotatable in the plane of the projections.

The intermediate member 602 has an outer spherical surface engaged with an inner concave surface of the outermost member 603. The second member and third member are coupled by axle shafts X23 and X23 coplanar (aligned with) with the projections M1, M11 so that the pair of members 602 and 603 are relatively rotatable orthogonally to the relative rotation of the pair of members 601 and 602.

Such a coupling is useful because the torque between the intermediate and outer members 602 and 603 is relatively lower than the torque between the inner and first intermediate members 601 and 602.

The projections M1 and M11 may be in intermediate member 602 projecting into slots in the inner member 601 in the example of FIG. 15.

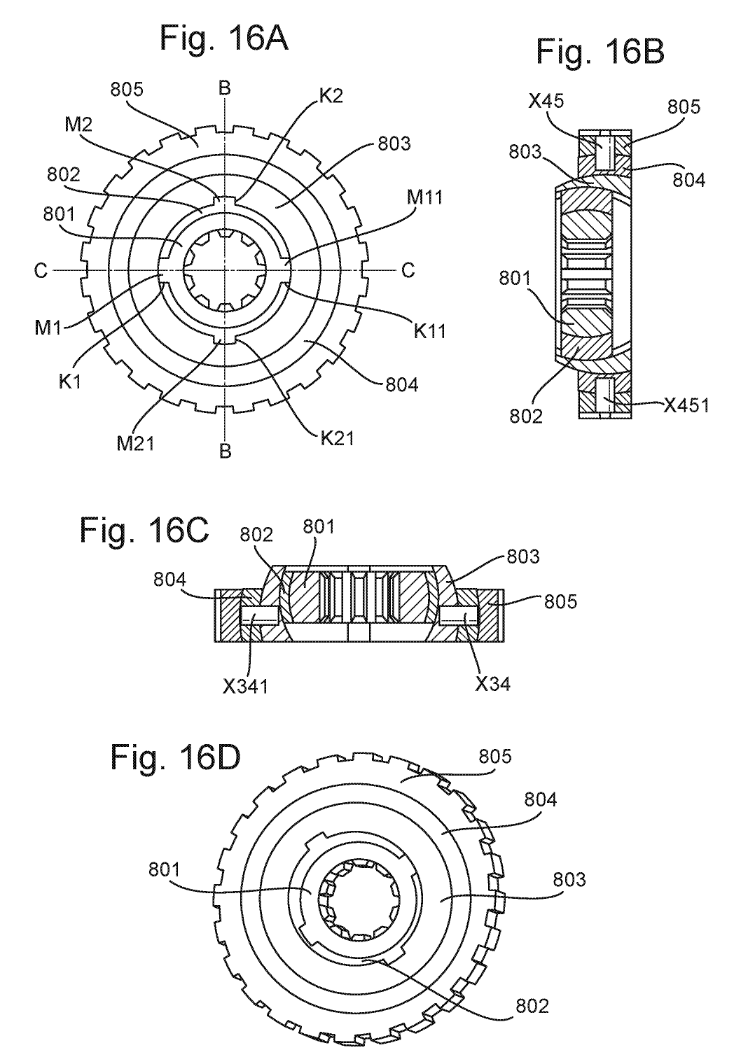

FIG. 16 shows a modification of the example of FIG. 8 in which the projections between the pairs of members comprising the second and third intermediate members 803 and 804 and the third intermediate member 804 and outmost member 805 are replaced by axles X34, X341, X45 and X451. There may be one axle shaft or, as shown, two diametrically opposite axle shafts coupling adjacent pairs of members 803 and 804, and 804 and 805 The third member is thicker radially than the third member of FIG. 8 because it must accommodate both slot(s) associated with projection(s) of the second member and axle shaft(s) connecting it to the fourth member. As shown in FIG. 8 the second intermediate member 803 provides an axial offset between the inner group of the inner member 801, first intermediate member 802 and second intermediate member 803 and the outer group of the second intermediate member 803, third intermediate member 804, and outermost member 805.

Such a coupling is useful because the torque at the outer group is relatively lower than the torque applied to the inner group.)

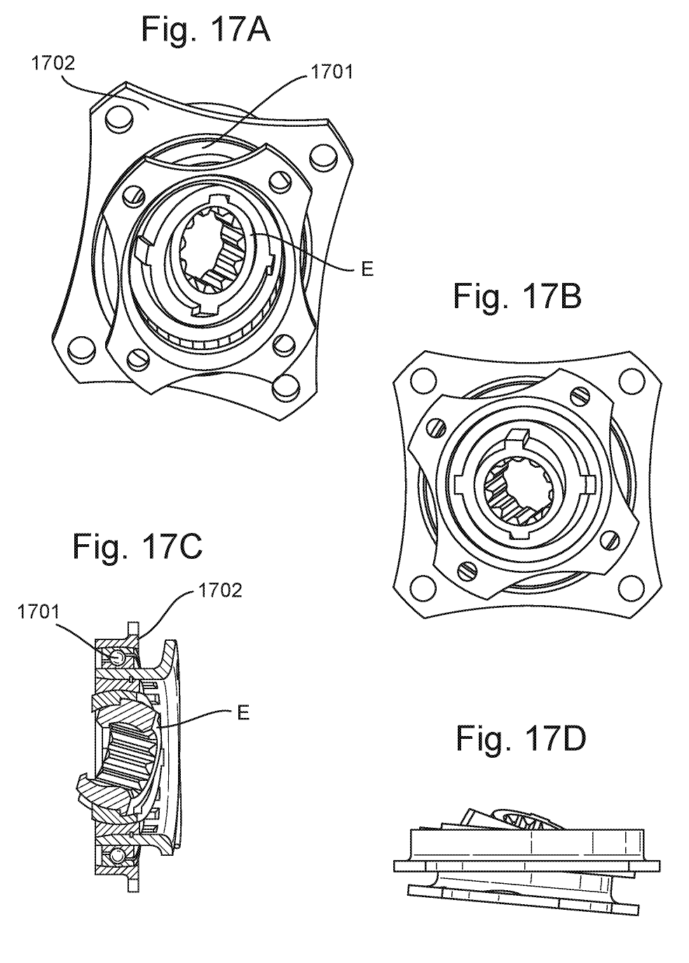

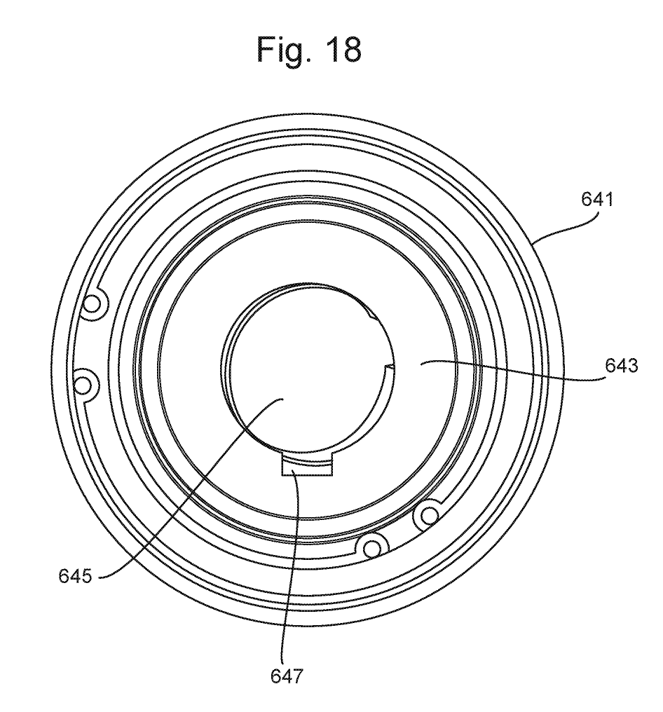

Referring to FIG. 17, any of the examples of a coupling shown in FIGS. 2, 6, 8, 14, 15 and 16 may be fixed within a bearing 1701 which may be fixed by for example a flange 1702 to a fixed structure for example a bulkhead, floor or wall. That allows the coupling to couple to any two structural elements, one each side of the fixed structure, that must be coupled with at least two rotational degrees of freedom. For example the fixed structure may be a bulkhead of a vehicle and the coupling the steering mechanism of the vehicle.

FIG. 17 shows one coupling within a bearing. In the examples of FIGS. 5 and 7 the two couplings joined in tandem by a tube 66, may be supported within a bearing around the tube 66.

In further arrangement a shaft is fixed to, or integral with the innermost, member of a coupling. In another arrangement, a shaft is fixed to, or integral with, the outermost, member of a coupling. Shafts may be fixed to, or integral with, both the innermost and outermost members of a coupling.

The examples described in FIGS. 1 to 17 may have splines in the inner member and or on the peripheral surface of the outermost member to connect the coupling to structural elements to be coupled.

Alternatively any other suitable means of connecting the coupling to structural elements may be used. For example the outer periphery may have screw thread for connecting it to a correspondingly threaded structural element. Likewise the central aperture as shown in FIG. 2, may have a screw thread or keys to couple to a shaft which is screw threaded or has keys slots. Especially for those examples having two or more projections on a member, the projections should share loads substantially equally. For plain bearing surfaces, the surfaces of the projections and slots should match accurately. Also for plain bearing surfaces, the mating convex and concave spherical surfaces should match accurately. That requires appropriately precise manufacture of the couplings.

In one illustrative method of making the couplings a lining material is injected between the projections and slots to provide a precise fit. Likewise a lining material may be injected between the spherical bearing surfaces. The convex spherical surfaces may be accurately machined. The convex spherical surfaces may be roughly machined to form a rough surface which is also a piece-wise linear approximation to a curved surface, and lining material injected between an accurately machined convex surface and the rough concave surface to form an accurately matched concave spherical surface. The convex spherical surface is coated with a release agent before the lining is injected into the coupling.

Plastic could be injected to provide the bearing liner material; the compositions of some of the plastics used for a liner are not known as the suppliers are commercially sensitive about their composition. However Delrin® is one known product that could be used or PTFE based materials could be used.

Couplings as described above made be of any suitable material. The examples having plain bearing surfaces may be of metal, e.g. high performance steels, brass, bronze, aluminium, titanium etc. and machined to shape or of plastic, e.g. nylon, glass filled nylon, acetal, ABS, Delrin® and moulded or machined to shape. In particular it can be seen that the use of loading slots as described with reference to FIG. 3 avoids the need to manufacture the annular members in two halves and bolt, weld or swage them together, which will always be a source of weakness, particularly in safety critical situations. It should be noted that the coupling of FIG. 6 may be configured so that the inner 601 and the outermost member 603 are connected to shafts or other structural elements with only the intermediate member 602 free to move relative to the other two members; this might lead a designer to select brass or bronze for the moving intermediate member middle and steel for the inner member 601 and outermost member 603. The same philosophy could be applied to the other couplings. The choice of material depends on the intended use of the coupling.

The above embodiments shown in FIGS. 1 to 17 are illustrative examples of the invention. Further embodiments of the invention are envisaged, and some are described blow with reference to FIGS. 18 to 48. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

In the specific examples in FIGS. 2 to 17, the inner member is an annular member with a central aperture to fit on a shaft. In some applications the inner member may have no central aperture, and can be bolted to a shaft or flange on the end of a shaft for example. Members other than the inner member have central apertures to allow a member within that member to nest.

In all the illustrated examples, the members comprise spherical segments having parallel sides. It is feasible to construct couplings in which the sides are not parallel, however, in practice, such constructions are likely to be awkward to deploy.

The inner member in all the examples comprises an annular spherical member with a central aperture for receiving a shaft. However, it may not have a central aperture but, for example, be bolted to a flange on a shaft.

In the examples shown, for maximum compactness, in each member of a pair of members comprising spherical segments has parallel sides in common planes when the segments are aligned. In particular:
in the arrangement of FIG. 2 each member of a pair of members comprises spherical segments has parallel sides in common planes when aligned;
in the arrangement of FIG. 6 each member comprises spherical segments having parallel sides in common planes when aligned;
in the arrangement of FIG. 8 the first pair of members (801, 802) each comprise spherical segments having parallel sides in common planes when aligned and the third pair of members (803, 804) and fourth pair of members (804, 805) each comprise spherical segments having parallel sides in common planes when aligned. This does not apply to the second pair of members (802, 803).

The discussion in the preceding paragraph, obviously, does not apply to a pairs of members in a coupling where the outer member of the pair has an enhanced operating range as shown in FIG. 12.

One specific example of use of the invention as a Spragg clutch is illustrated in FIGS. 18 to 22.

The clutch comprises an inner annular member 601, having a central bore 611 receive a driving shaft (not shown), with a keyway 612 to receive a keyway on the driving shaft and to force the inner annular member 601 to rotate with the driving shaft, and intermediate member 602 and an outer member 603. The arrangements of the inner, intermediate and outer members are as described in FIGS. 1A to 1C with the inner member having a convex spherical outer surface S1 having diametrically opposed projections M1, M11 received into slots K1, K11 in the concave inner peripheral surface S21 of intermediate member 602. The outer convex peripheral surface has diametrically opposed projections M2, M21 received into slots K2, K21 in the convex inner periphery of outer member 603. The planes containing projections M1, M11 on the one hand and M2, M21 on the other are orthogonal to one another, with the result that the axis of rotation of outer member 603 about intermediate member 602, is orthogonal to the axis of rotation in intermediate member 602 about inner member 601.

Rather than projections engaging in slots, the one or more of the projections and slots between the intermediate member(s) and/or between the outer member and the intermediate member contained in the outer member one or more pairs of projections and slots, M2, M21, K2, K21 shown in the drawings, for example, may be replaced by axles as shown in FIG. 16, but it should be noted that if such a replacement occurs the axis to the axles should be on the proposed axis of rotation of one member 603, about another 602.

The outer member 603 has an annular extension 631 laterally but opposite the direction 613 from which a shaft may be inserted into the central bore 611 of annular member 601. This annular extension 631 forms the body of a Spragg mechanism 641. The Spragg mechanism itself is conventional and comprises an annular member 643 with a central bore 645 and a key way 647 formed in the periphery of the bore to receive the key of a shaft (not shown) to be driven by the mechanism. The outer periphery 649 of the annular member 643 has three slots 651 with rounded inside surfaces 655 to receive the rounded ends of Spraggs 657 mounted to rotate about a spring wire hoop 659 around the outer periphery 649 of annular member. The slots 651 are distributed evenly around the outer periphery 649. The spraggs have tails 661 which are pushed by the spring wire 659 into the teeth 663 of an internal ratchet 665. The teeth 663 are in the form of saw teeth, permitting the spraggs 657 to pass in one direction only.

Each end of the outer periphery of the annular member 643 has a stepped portion 666; annular bearings 667 are mounted in the stepped portions 666 of the annular member 643.

The mechanism 641 is held in place within the annular extension 631 with circlips 669 and 671.

The dutch mechanism as shown also incorporates a seal to retain oil lubricant within the coupling part of the device and to exclude dust and grit.

The outer member 603 has an inner step 632 at its edge opposite the annular extension 631. The inner step 632 retains seal support discs 18 having central apertures 20 around the convex periphery S1 of inner member 601. Ring seals 22 are fitted to the rim 24 of the seal support apertures 20 closing any space between the rims 24 and the convex outer surface S1 of inner member 601.

The sides 621 joining the convex outer periphery S22 and the inner concave periphery of intermediate member S21 are inclined inwards from the outer periphery of the member to the inner periphery of the member. The purpose of the inclined sides is to allow the intermediate member 602 greater range of movement before one of the sides 621 or the other contacts the seal support discs 18. If the sides were parallel the range of rotation of intermediate member 602 about inner member 601 would be restricted.

The intermediate member has ducts 150 to allow the passage of lubricant between its outside surface S22 and inner peripheries S21.

The inner and intermediate member 601 and 602 have ducts 132 and 152 leading from the sides of the projections M1, M11 M2, M21 to the outer surfaces of projections.

In operation, as the members rotate with respect to one another, the gaps between the sides 621 of the intermediate member and the seal support disc 18 will increase and decrease as the annular member 602 is rotated. This has the effect of pumping lubricant around the device.

Overall, the invention enables a Spragg clutch to operate between an input rotor and an output rotor, having angular misalignment. In the embodiment illustrated, misalignment of up to 15 degrees can be accommodated.

The open design of the couplings as shown in FIGS. 2 to 22 can lead to loss of lubricant in wet lubricated versions of the couplings and in any version, whether wet lubricated of not, to the ingress of dust and grit, which leads to wear, especially of the projections, slots, axles and bores in which they operate. This can be avoided by the use of seals as discussed below.

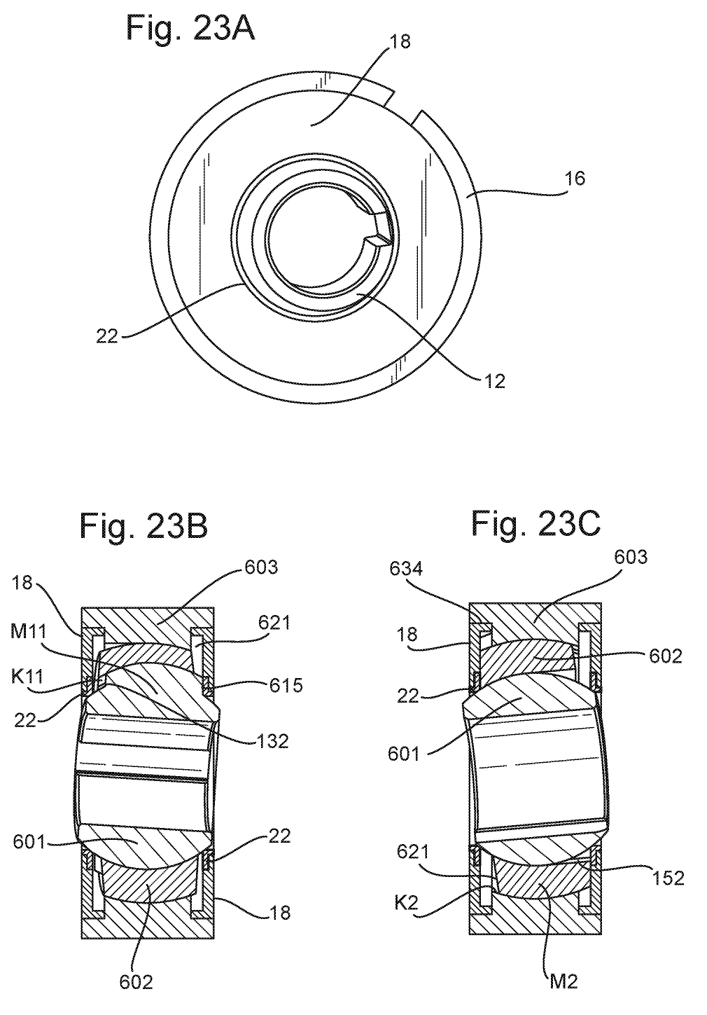

FIGS. 23 to 26 show a coupling which is similar to the coupling shown in FIG. 6 but with the flange 44 (as shown in FIG. 6) omitted and according to the invention.

In FIGS. 23 to 26 a coupling to the invention comprises a first, inner annular member 601, intermediate annular intermediate member 602 and an annular outermost member 603. Each of the members 601, 602, 603 comprises spherical segments about a common centre (the point C in FIG. 1). The inner annular member 601 has an outer peripheral surface S1 which is convexly spherical centred on the point C. The first inner annular member 601 has a central bore 40 which in this example has a keyway 42 engaging a correspondingly splined shaft.

The intermediate annular member 602 has an inner peripheral surface S21 which is concavely spherical complementary to the outer surface S1 of the first inner member 601.

Diametrically opposed elongate projections M1, M11 extend radially of, and parallel to the axis of annular member 601 from the convex spherical surface S1 of the inner member 601. The radially outer surfaces of the projections M1, M11 also extend parallel to the spherical surface S1, alternatively the outer surfaces of the projections M1, M11 can be cylindrical The projections extend into complementary slots K1, K11 in the inner concave surface S21 of the intermediate member 602. The projections M1, M11 and slots K1, K11 constrain the first inner member 601 and intermediate member 602 to rotate one relative to the other about a second axis of rotation which is perpendicular to the axis (the first axis) of the inner annular member 601.

The intermediate member 602 has an outer periphery S22 which is convexly spherical. The outermost annular member 603 has an inner peripheral surface S31 which is concavely spherical complementary to the outer surface S22 of the intermediate member 602.

Second elongate projections M2, M21 extend radially of, and parallel to, the first axis from the convex spherical surface S22 of the intermediate member 602. The radially directed outer surfaces of the second projections M2, M21 also extend parallel to the spherical surface S22; alternatively the outer surfaces of the projections M2, M21 can be cylindrical.

The projections M2, M21 extend into complementary, second, slots K2, K21 in the inner concave surface S31 of the outermost member 603. The second projections M2, M21 and second slots K2, K21 are orthogonal to the first projections M1, M11, and first slots K1, K11. They constrain the intermediate 602 and outermost 603 members to rotate one relative to the other about a third axis of rotation which is perpendicular to both the first axis and second axis.

The inner member 601 is retained in the intermediate member 602, and the intermediate member 602 is retained in the outermost member 603. For this purpose, the intermediate member 602 has parallel loading slots 620, and the outer member 603 has parallel loading slots 630. The inner member 601 is inserted into the central aperture of member 602 using loading slots 620 and then turned to be retained by the concave inner surface S21 of member 602. The intermediate member 602 thus retains the inner member 601. The intermediate member 602 is retained in the outer member 603 by inserting intermediate member 602 into the central aperture of member 603 using loading slots 630 and then turning intermediate member 602 to be retained by the concave inner surface S31 of member 603.

The outer ring has an inner step 634 at each edge. The inner steps 634 retain seal support members which in this case are seal support rings 18 comprising the having central apertures 20 around the convex periphery S1 of inner member 601. Ring seals 22 are fitted to the rim 24 of the seal support apertures 20, closing any space between the rims 24 and the convex outer surface S1 of inner member 601. The sides 621 joining the convex outer periphery S22 and the inner concave periphery S21 of intermediate member 602 are inclined inwards from the inner periphery of the member to the outer periphery of the member as seen in FIGS. 23A and 23B.

The purpose of the inclined sides 621 is to allow the intermediate member 602 greater range of movement before one of the sides 621 or the other contacts the seal support rings 18. If the sides were parallel, the range of rotation of intermediate member 602 about inner member 601 would be restricted. The benefit of the bevelled sides can be seen in FIGS. 23B and 23C.

In a wet lubricated joint, the intermediate member 602 has a duct 150 to allow the passage of lubricant between their outside peripheries (S1 and S22) and their inner peripheries.

The inner member 601 and intermediate member 602 have ducts 132 and 152 leading from the sides 614 and 624 the projections M1, M11, and M2, M21 to outer surfaces of projections M1, M11 and M2, M21 respectively.

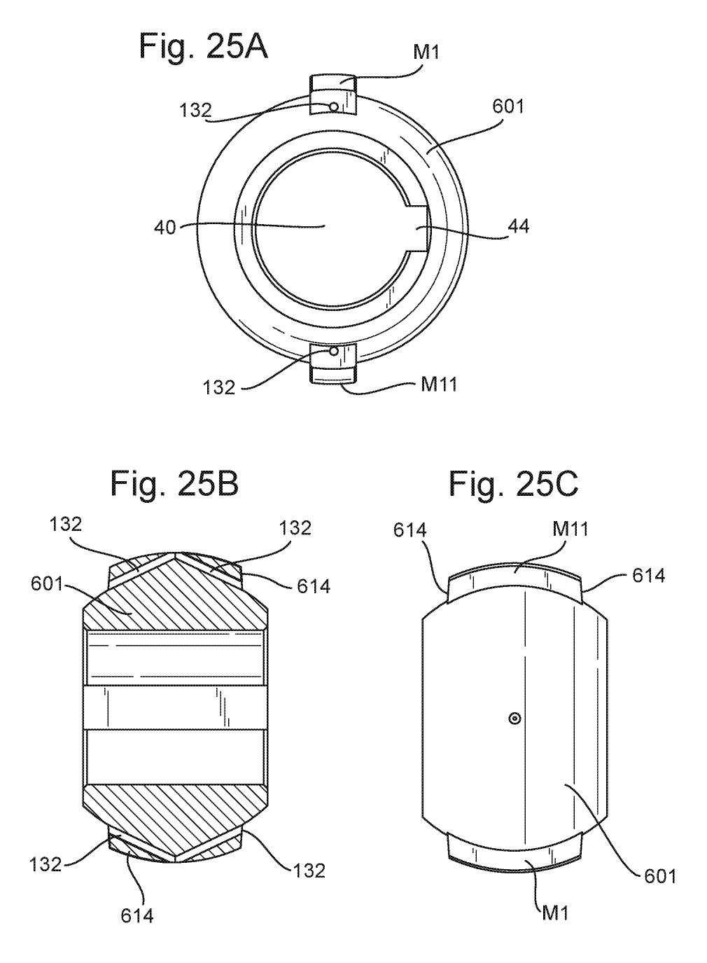

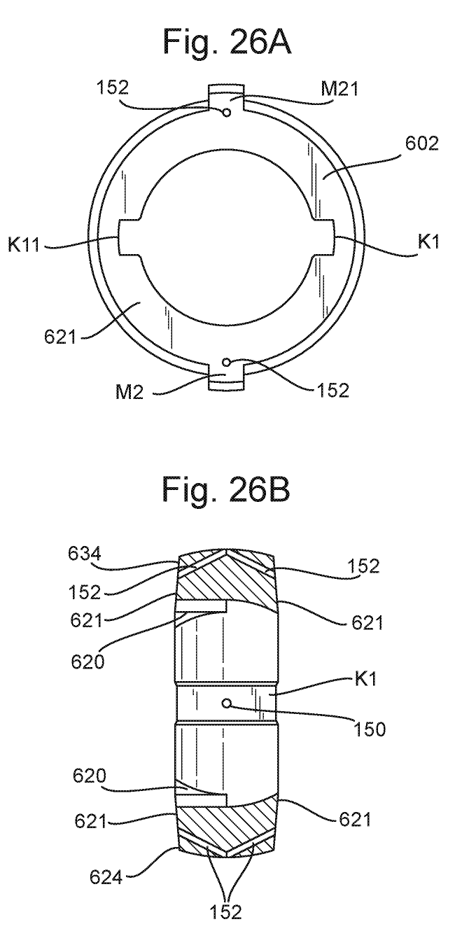

The arrangements for the inner annular member 601 can be seen more clearly in FIG. 25 and for the intermediate annular member 602 in FIG. 26. Visible in FIGS. 25 and 26 is the fact that the sides 614 and 624 of the projections M1, M11 and M2, M21 slope towards one another travelling from the periphery of the member concerned to their extremity of the projection(s) in the slot(s) to allow the projections M1, M11 and M2, M21 maximum movement in their slots K1, K11 and K2, K21 respectively. In FIG. 6B too it can be seen that duct 150 enters the slots K1, K11 on the inner periphery S21 of intermediate member 602.

One use of the coupling of FIGS. 23 to 26 is a universal joint as it allows angular misalignment of shafts by virtue of the relative rotation of the inner and outermost members about the second axis. To allow a shaft to be connected into the central aperture 40 of the inner member 601, a keyway or splines 44 is/are provided into which a spline(s) of a shaft engages. The outer ring 603 is also provided with a slot 633 into which and internal key or splines of a second shaft can be engaged.

In operation, as the members rotate with respect to one another, the gaps between the sides 621 of the intermediate member and the seal support rings 18 will increase and decrease on each side of the intermediate member 602 alternately. The decrease in the gap has the effect of pumping lubricant in the gaps whose size is decreasing though the ducts 152, and then one through duct 150. Likewise movement of projections M1, M11 in slots K1, K11, and projections M2, M21 in slots K2, K21 forces lubricant into and out the gap between the sides 614 and 624 of the projections M1, M11 and M2, M21 establishing a pumping action which circulates lubricant though ducts 132, 150 and 152.

In the embodiment of FIGS. 23 to 26 but with a coupling comprising an inner member, three intermediate members, and an outer member as shown in FIG. 8. Two pairs of seals and seal mounting rings are provided, one pair of seals rings mounted in steps at the ends of the concave inner surface of outer member and with their associated seals engaging the outer convex spherical periphery of the second intermediate members, and the second pair of seal rings mounted in steps at the ends of the inner concave periphery of the second intermediate member with the associated seals engaging the outer convex periphery of the inner member.

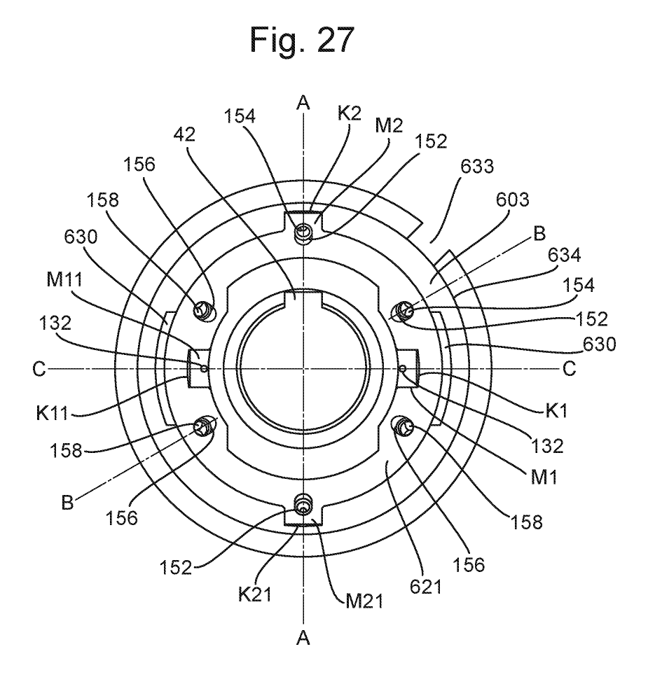

Large couplings transmitting high torques at high speed may experience wear of the spherical surfaces of the annular members. The coupling of FIGS. 27 to 37 shows a number of additional measures which may be used to enhance lubrication of couplings of the invention.

The coupling of FIGS. 27 to 37 have the same main components as the coupling described with reference to FIGS. 23 to 26, although these components are shown in FIGS. 27 to 37, they are not described again in detail, and the reader should refer to FIGS. 23 to 26 for detail of these.

In FIGS. 27 to 37 ducts 161 pass between the slots K2, K21 and the outer spherical surface of the intermediate member 602, these into galleries 160 for grease or other lubricant to flow.

Annular grooves 162 and 164 are provided circumferentially around the inner periphery of intermediate member 602 and outer member 603 respectively, these are again to assist movement of lubricant around the coupling.

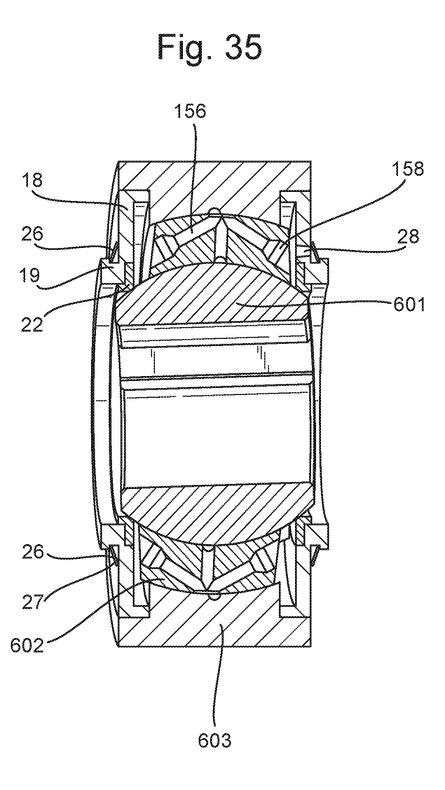

Further additional radial ducts 160 are through the intermediate member 602 linking the grooves 162 and 164. These radial ducts 160 join, on reaching the peripheral outer surface of intermediate member 602, with ducts 156, which pass through the sides 624 of intermediate members 602 and are routed to the outer peripheral surface as shown. Slit valves are 158 provided in the ducts 156 (see FIG. 35). The slit valves allow flow of lubricant from the sides 624 of intermediate member to the groove 164 under the action of the closing of the gap between the sides 624 of intermediate member 602 and seal support rings 18 in one direction only.

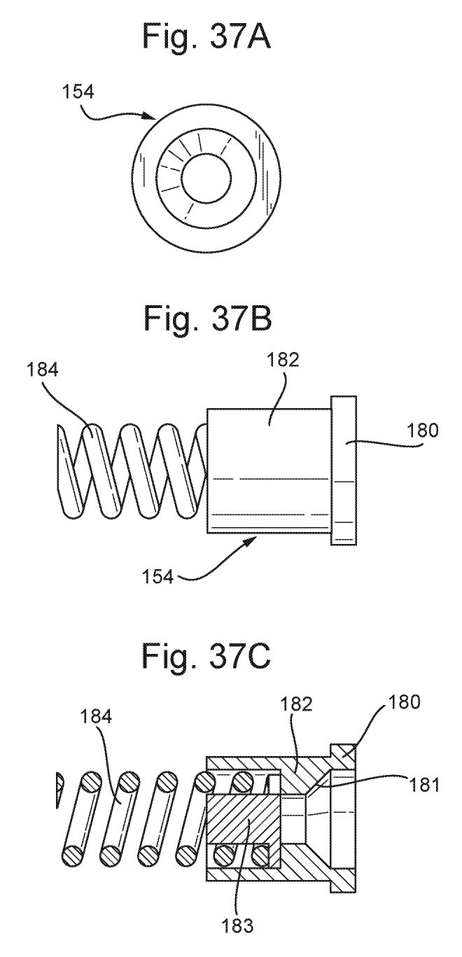

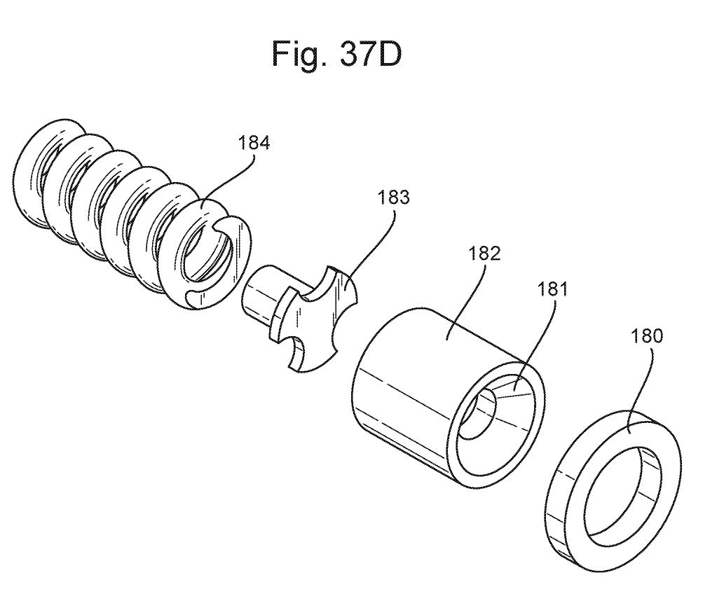

The ducts 152 are provided with centrifugal pump valves 154 which open and close to provide a pumping action caused by opening and closing of the space between the seal support ring 18 and the sides 624 of intermediate member and 621 of projections M2 and M21. Detail of centrifugal valves 154 is seen in FIGS. 37A to 37D. A spring 184 seated in the duct 152, urges a valve 183 against valve seat 182, in a plunger body 180, with a mouth 181 leading to the valve 183. The movement of the sides 624 of the intermediate member and of the sides 621 of projections M2, M21, increases and decreases the volume of the space 133 between the sides 621 and 624 and the seal support ring 18. As the space 133 decreases, pressure on lubricant in that area increases forcing the valve 183 open against the spring 184 so that any lubricant in the mouth 181 is forced past the valve 183. Once the peak pressure has passed after the spring closes the valve will close against seat 182 thus trapping lubricant behind the valve. As the speed of rotation of the coupling increases the centrifugal effect on the plunger 180 causes it to travel outwards along the duct 152 and thus the plunger 180 is forced further against the spring 184, this has the effect of increasing the pressure on the closed valve, increasing its sealing effect preventing back flow of lubricant from the outer periphery of the intermediate, it also forces lubricant from the duct 152 into the groove 164 and through the ducts 161 into the area around the projections and also into the rest of the coupling through the lubrication grooves 162 and 164 and galleries 160 again in one direction only.

In some applications the spring 184 may be replaced by springs of different strengths, one urging against the valve 183, the other urging plunger 180. The centrifugal valves 154 are best placed on a central plane of the coupling to maximise the centrifugal effect on the valves. The valve will provide for a continuous lubricant flow when used in rapid start/stop operations.

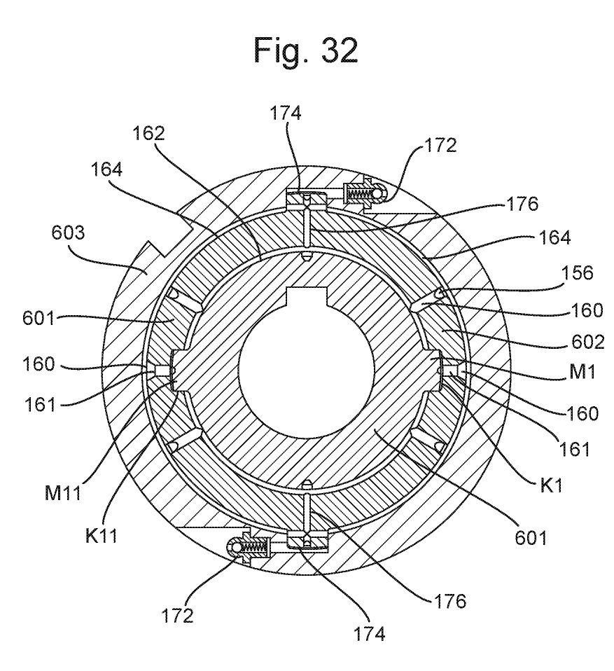

The outer annular member 603 has an inset portion 170 set in to its outer surface (see FIG. 31). A grease nipple 172 is mounted in the inset 170 with a duct leading to an injector 174 opposite a further duct 176 passing between the outer periphery and inner periphery of the intermediate members, allowing grease to be injected into the groove 162 and 164 though the ducts 132 projections M1, M11 projections and ducts 160 (see FIG. 32 especially).

The coupling has the seal and seal support rings in place as described with reference to FIGS. 23 to 26, but in this case each seal support rings 18 has a seat 19 around its outside diameter. Seated in seat 19 is an over-pressure flap valve 26 which can be a sprung steel ring (as shown—with a slit 27 to allow opening and closing) or an elastomeric material or fibreglass. The seal support rings have a plurality of holes 28 through it to allow excess lubricant through to be released from the coupling through the over-pressure flap valve 26.

The valve 183 of the centrifugal valve 154 can be changed for one a different design to that shown, for example a bucket seal of the kind used in bicycle pumps could be used. They use the pressure on one side to cause the valve to open out against the bore providing a better seal. In the reverse direction the seal collapses away from the bore allowing lubricant to pass.

The grooves 162 and 164 are described as being around the inner peripheries of the outer and intermediate annular members; they could also be formed in the outer peripheries of the intermediate and inner members respectively.

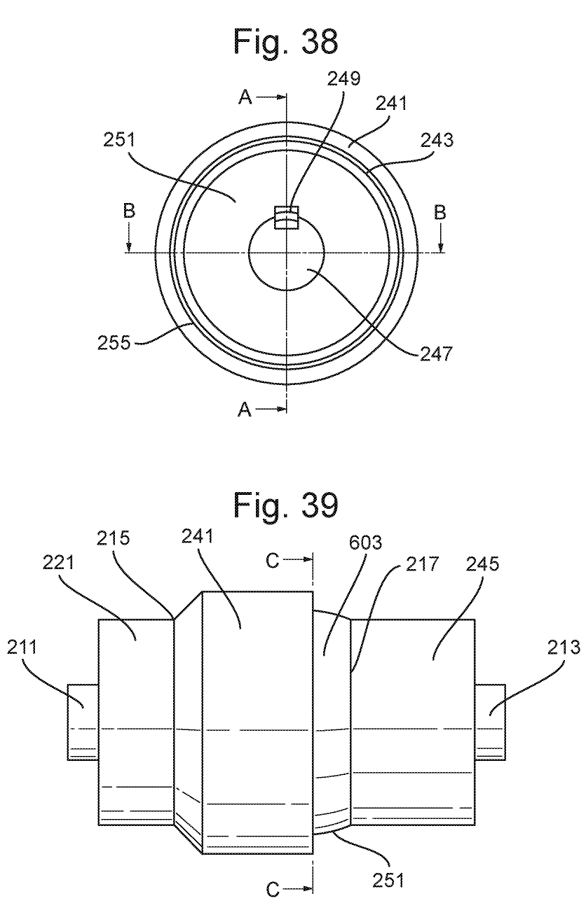

An alternative embodiment to those illustrated with reference to FIG. 23 to 26 is shown in FIGS. 38 to 46. Conventional couplings are generally shrouded by a “boot” to provide sealing against egress of lubricant and ingress of contaminants and assist impact or blast damage resistance. This invention provides much neater and lighter couplings for many safety, weight and size critical applications with the embodiment of FIGS. 38 to 46 showing how improved blast or impact resistance can be achieved.

In FIGS. 38 to 46, a coupling between an input shaft 211 and an output shaft 213, comprises an input hub 215 and an output hub 217. For clarity the input and output shafts 211 and 213 are only shown in FIG. 39.

The input hub 215 has, at one end; a cylindrical profile 221, with a central bore 223 into which the input shaft 211 can be inserted. A longitudinal keyway 225 is provided in the central bore 223 to receive a key on the input shaft 211. The other end of the input hub 215 has a shaft 227 extending into the central bore 229 of inner annular member 601 of the coupling. The shaft 227 has a keyway 231, with the inner bore of the inner annular member 601 having a corresponding keyway 233. A key 235 is inserted in the keyways 231 and 233 to pass rotational movement of shaft 227 to inner annular member 601.

The coupling comprises a first, inner annular member 601, intermediate annular intermediate member 602 and an annular outermost member 603. Each of the members 601, 602, 603 comprises spherical segments about a common centre C (the same as the point C in FIG. 1). The inner annular member 601 has an outer peripheral surface S1 which is convexly spherical centred on the point C.

The intermediate annular member 602 has an inner peripheral surface S21 which is concavely spherical complementary to the outer surface S1 of the first inner member 601.

Diametrically opposite elongate projections M1, M11 extends radially of, and parallel to the axis of annular member 601 from the convex spherical surface S1 of the inner member 601. The radially outer surfaces of the projections M1, M11 also extend parallel to the spherical surface S1, alternatively the outer surfaces of the projections M1, M11 can be cylindrical The projections extend into complementary slots K1, K11 in the inner concave surface S21 of the intermediate member 602. The projections M1, M11 and slots K1, K11 constrain the first inner member 601 and intermediate member 602 to be rotatable one relative to the other about a second axis of rotation through but perpendicular to the axis of the inner annular member 601—the first axis.

The intermediate member 602 has an outer periphery S22 which is convexly spherical. The outermost annular member 603 has an inner peripheral surface S31 which is concavely spherical complementary to the outer surface S22 of the intermediate member 602.

Second elongate projections M2, M21 extend radially of, and parallel to, the first axis from the convex spherical surface S22 of the intermediate member 602. The radially outer surfaces of the second projections M2, M21 also extend parallel to the spherical surface S22, alternatively the outer surfaces of the projections M2, M21 can be cylindrical.

The projections M2, M21 extend into complementary, second, slots K2, K21 in the inner concave surface S31 of the outermost member 603. The second projections M2, M21 and second slots K2, K21 are orthogonal to the first projections M1, M11, and first slots K1, K11. They constrain the intermediate 602 and outermost 603 members to be rotatable one relative to the other about a third axis of rotation and perpendicular to both the first axis and second axis.

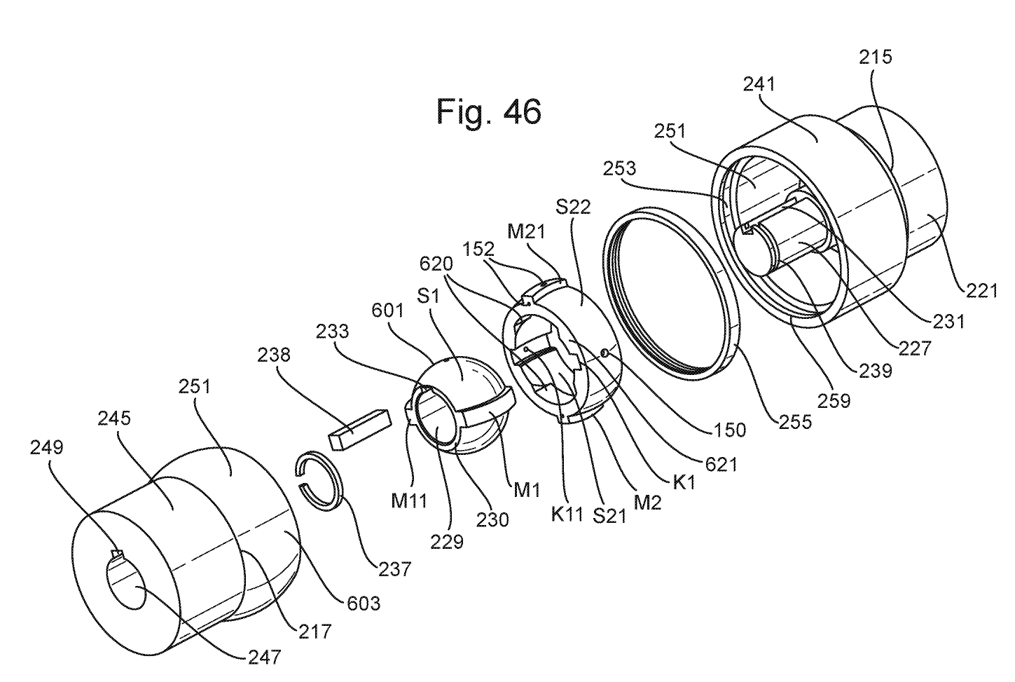

The inner member 601 is retained in the intermediate member 602, and the intermediate member 602 is retained in the outermost member 603. For this purpose the intermediate member 602 has parallel loading slots 620, and the outer member 603 has parallel loading slots 630. The inner member 601 is inserted into the central aperture of member 602 using loading slots 620 (seen in FIG. 46) and then turned to be retained by the concave inner surface S21 of member 602. The intermediate member 602 thus retains the inner member 601. The intermediate member 602 is retained in the outer member 603 by inserting intermediate member 602 into the central aperture of member 603 using loading slots 630 (seen in FIGS. 45 and 46) and then turning intermediate member 602 to be retained by the concave inner surface S31 of member 603.

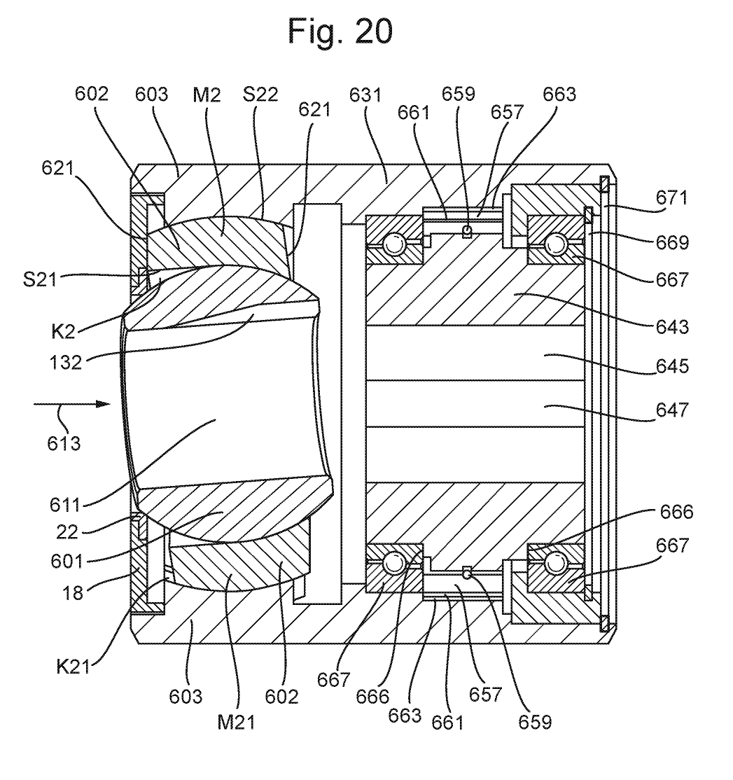

The input hub 215 also has a housing 241 which in this embodiment is the seal support member extending partially around the outside of the coupling. The inner surface of the housing has a hemispherical spherical inner surface 243. The hemispherical surface 243 extends around one half of the outer annular ring to a plane on the line HH (in FIG. 20), line HH is which is also the axis of rotation A2 as in FIG. 6. Beyond the plane intersecting the line HH, the housing is cut away to provide a surface 259 that is parallel to the axis A1 of the coupling. This cut away portion 259 enables the outer annular ring to be fitted into housing. The function of this housing 241 and its hemispherical inner surface 243 is described further below. Shaft 227 projects from the hemispherical surface 243 into bore 229 of the inner annular member 601.

The outer member 603 has a contiguous cylindrical extension 245, extending from the coupling in an opposite direction to the cylindrical profile 221 of input hub 215. Together the outer member 603 and the extension 245 form the output hub 217. Cylindrical extension 245 has an inner bore 247 into which output shaft 213 may be received. The bore has a keyway 249 to receive a key on the output shaft 213, thus to pass torque and rotational motion of the outer annular member 603 to the output shaft 213.

The outer surface of outer annular member 603 is has an outer spherical surface 251 corresponding to the hemispherical inner surface 243 of housing 241. The hemispherical housing and the outer annular member 603 can, in the design illustrated, rotate about each other by up to 17.5°. By altering the relative dimensions of the components the degree of rotation can be increased or decrease, but any increase may come with a lessening of the overall strength of the coupling.

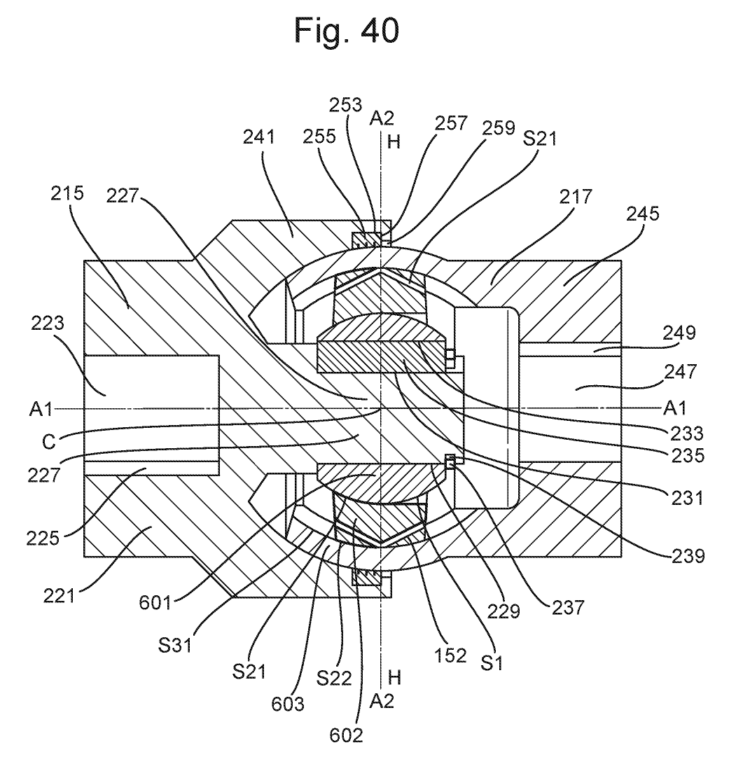

The periphery of the hemispherical inner surface 243 of the housing 241 has a groove 253 in which an annular seal 255 is housed, the seal 255 sealing between the housing 241 and the outer spherical surface of the outer annular member 603. The spherical inner surface 243 of the housing and the outer spherical surface 251 of the outer member 603 are also centred on point C (i.e. they are concentric with the spherical surface S1, S21, S22 and S31 of the annular members 601 (S1), 602 (S21, S22), 603 (S31), and a seal plane H-H (marked in FIG. 40) is formed at the edge 257 of seal 255 and passing through the centre point C. It is possible to construct the groove 253 slightly further to the left as seen in FIG. 40, so that the plane HH passes through a point on the axis A1 further to the left (when viewed as in FIG. 40).

A snap ring 237 engaging in a circumferential groove 239 in shaft 227 bears on the one side 230 of the inner annular member 601 holding the input hub (and thus housing 241) in place with respect to the rest of the assembly, and the outer spherical surface of the 251 of the outer member in particular. The snap ring 237 also holds key 235 in place in keyways 231 and 233.

To assemble the coupling inner annular member 601 is located within intermediate ember 602, and intermediate member within outer member 603 as described previously. Key 235 is located in keyway 231 and snap ring 237 is over-compressed within grove 239. The shaft 227 is then forced through the bore 229 of the inner annular member 601. When the snap ring 237 reaches the opposite end of bore 229 it expands locating against side 230 of the inner annual member, locking the whole assembly in place. As shown in the figures the snap ring has a rectangular cross section, and once the snap ring is located in pace, the assembly is not easily dismantled. A circular cross section snap ring would be used should it be required to dismantle the assembly more easily. In an embodiment in which the shaft 227 and the bore 229 of inner annular member 601 have co-operating splines (for example the splines 42 of FIG. 6), the groove 239 may be formed in the splines, and the snap ring expanded into place in the groove in the splines in bore 229

By looking at FIG. 40 it can be seen that the coupling is completely sealed and dust and grit excluded by a combination of the shape of the input hub 215 and the seal 255 engaging the outer surface 251 of the outer annular member 603 thus in a wet lubricated coupling oil is completely sealed within the coupling.

As described previously with respect to FIGS. 23 to 37, in the embodiment of FIGS. 38 to 46, the sides 621 joining the convex outer periphery S22 and the inner concave periphery S21 of intermediate member 602 are inclined inwards from the inner periphery of the member to the outer periphery of the member.

In a wet lubricated joint, the intermediate member 602 has a duct 150 to allow the passage of lubricant between their outside peripheries (S1 and S22) and their inner peripheries.

The inner member 601 and intermediate member 602 may also have ducts 132 and 152 leading from the sides 614 and 624 the projections M1, M11, and M2, M21 to outer surfaces of projections M1, M11 and M2, M21 respectively as discussed in FIGS. 23 to 37.

In operation, as the members rotate with respect to one another, the gaps between the sides 621 of the intermediate member and input hub 215 on the one hand and the output hub 217 on the other will increase and decrease on each side of the intermediate member 602 alternately. The decrease in the gap has the effect of pumping lubricant though the ducts 152 and through duct 150. Likewise movement of projections M2, M21 in slots K2, K21 forces lubricant into and out the gap between the sides 624 of the projections M2, M21 establishing a pumping action which also circulates lubricant though ducts 150 and 152.

As shown the coupling of FIGS. 38 to 46 can cope with misalignments of up to 17.5° between an input shaft 211 and an output shaft 213 connected to an input hub 215, However by reducing the diameter of body 245 of the output hub 217, the degree of misalignment can be increased, although with the risk that the overall strength of the coupling will weaken.

For large coupling transmitting high torques at high speed where wear of the spherical surfaces of the annular members, the additional features of FIGS. 27 to 37 may be applied to the embodiment of FIGS. 23 to 26 may be used to enhance lubrication of couplings of the invention.

The sealing system, shown in FIGS. 38 to 46 is strong and robust, although an additional convoluted rubber sheath could be fitted around the outside of the coupling as an additional safeguard against ingress of contaminants and egress of lubricants.

The construction of FIGS. 38 to 46 can be applied to a coupling having more than one intermediate annular member, say, a coupling having three intermediate members as described with reference to FIG. 8.

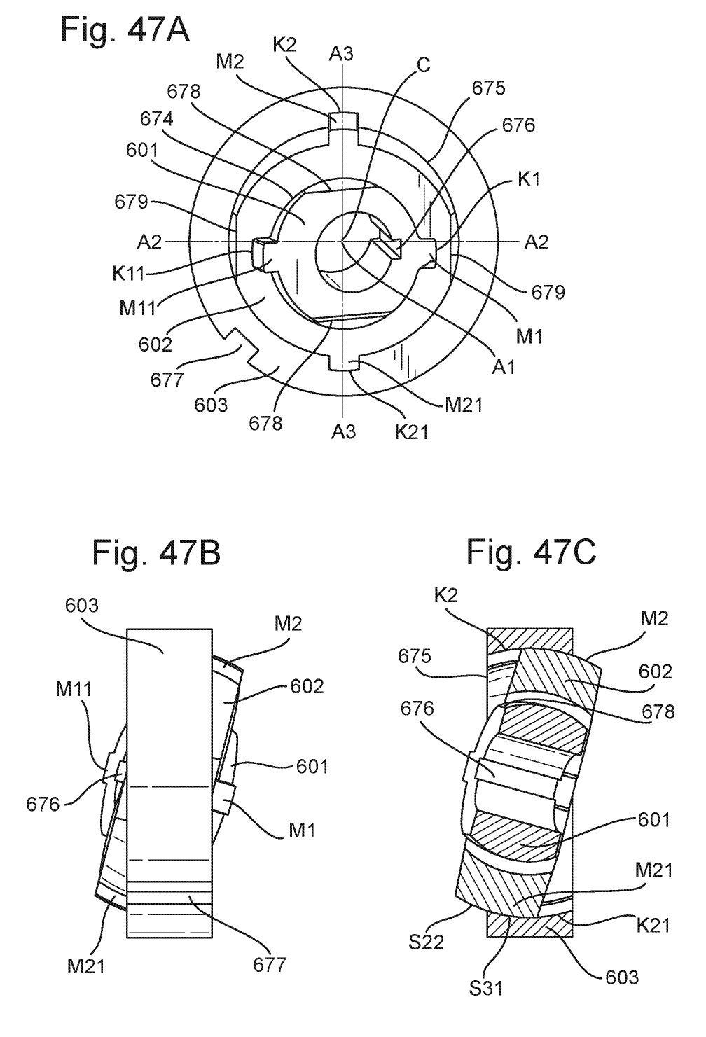

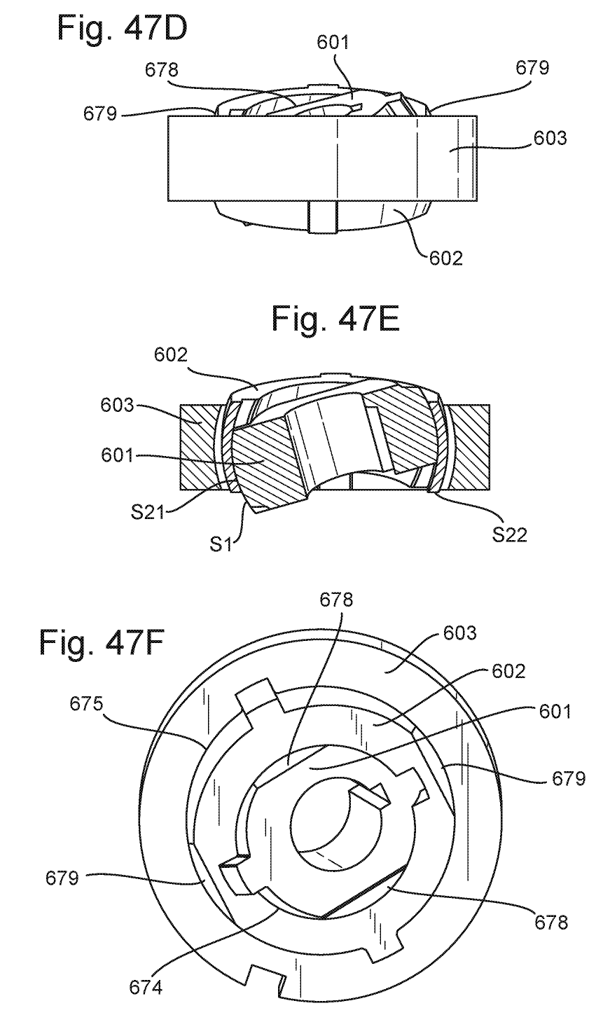

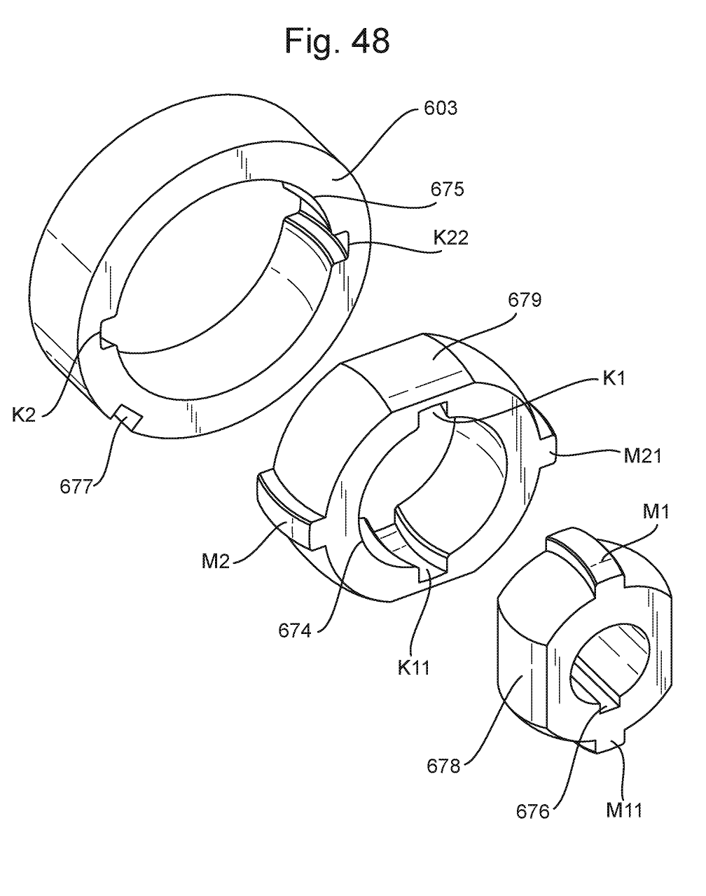

FIGS. 47 and 48 show a coupling like that of FIG. 6 comprising a first, inner annular member 601, annular intermediate member 602 and an annular outermost member 603. Each of the members 601, 602, 603 comprises spherical segments about the centre C. The inner annular member 601 is centred on a first axis A1, the inner annular member 601 having an outer peripheral surface S1 which is convexly spherical centred on the point C on the axis A1. In this case the he first inner annular member 601 has a central bore which in this example has a keyway 676 engaging a corresponding key on a shaft.

The intermediate annular member 602 has an inner peripheral surface S21 which is concavely spherical complementary to the outer surface S1 of the first inner member 601. In this example the inner spherical surface S21 of the intermediate member 602 forms a female bearing surface and the outer spherical surface S1 of the first inner member the male bearing surface.

Diametrically opposite elongate projections M1 and M11 extends radially of, and parallel to, the first axis A1 from the convex spherical surface S1 of the inner member 601. The radially outer surface of the projection also extends parallel to the spherical surface S1 but can also be cylindrical in nature. The projections extend into complementary slots K1 and K11 in the inner concave surface S21 of the intermediate member 602. The projections M1, M11 and slots K1 K11 constrain the first inner 601 and intermediate member 602 to be rotatable one relative to the other about the second axis A3 of rotation through and perpendicular to the first axis A1.

The intermediate member 602 has an outer periphery S22 which is convexly spherical and forms a second male surface. The outermost annular member 603 has an inner peripheral surface S31 which is concavely spherical complementary to the outer surface S22 of the intermediate member 602. The inner spherical surface S31 of the outermost member forms a second female bearing surface.

Second elongate projections M2 and M21 extend radially of, and parallel to, the first axis from the convex spherical surface S22 of the intermediate member 602. The radially outer surface of the second projections M2 and M21 also extends parallel to the spherical surface. But can also be cylindrical in nature.

The projections M2 and M21 extend into complementary, second, slots K2 and K21 in the inner concave surface of the outermost member 603. The second projection M2 and M21 and second slots K2 and K21 are perpendicular to the first projections M1, M11, and first slots K1, K11. They constrain the intermediate 602 and outermost 603 members to be rotatable one relative to the other about the third axis A2 of rotation through the centre point C, and perpendicular to both the first axis A1 and second axis A3.

In this example outer member 603 has a keyway 677 to receive an internal key of a shaft to which it may be connected.

The inner member 601 is retained in the intermediate member 602 by the male bearing surface S1 constrained within female race S21, and the intermediate member 602 is retained by the male bearing surface S22 within female race S31.

In this example the projections M11 and M21 and corresponding slots K11 and K21 could be omitted but with less security in the event of failure.

The male bearing surface S1 of inner member 601 has a cylindrical waist 678, the waist form a loading slot whose axis is coincident with axis A2 and orthogonal to the first axis A1. The diameter of the cylindrical waist is just less than the aperture 674 of intermediate member 602.

To assemble the inner member 601 within the intermediate member 602, inner member 601 is lined up within intermediate member 602 to be at right angles to intermediate member 602, but with projections M1 and M11 aligned with their corresponding slots K1 and K11. Inner member 1 is now rotated to bring surface S1, the male spherical bearing surface into contact with the inner periphery S21 of the intermediate member 602.

Similarly, the male bearing surface S21 of intermediate member 602 has a cylindrical waist 679 whose axis is coincident with axis A3 and orthogonal to the first axis A1. The diameter of the cylindrical waist is just less than the aperture 675 of intermediate member 603.

To assemble the intermediate member 602 within the outer member 603, intermediate member 602 is lined up within outer member 603 to be at right angles to intermediate member 603, but with projections M2 and M21 aligned with their corresponding slots K2 and K21. Intermediate member 602 is now rotated to bring surface S22 the male spherical bearing surface into contact with the inner periphery S31 of the outer member.

The arrangements of FIGS. 47 and 48 may be used in conjunction with the embodiments by replacing the intermediate member as shown in those figures with one of the kind shown in FIGS. 23 and 37, which has a waist 679 in the outer surface S22, but loading slots in the inner surface S21. It would not in the construction shown in FIGS. 47 and 48, be possible to provide waists in the outer surface S1 of the inner member as that prevent the seal 22 from sealing against the outer surface S1 of the inner member 601.

In addition to aiding loading the intermediate member 602 in the outer member 603, the space thus formed between the waisted portion 679 and the inner periphery S31 of the outer member 603 acts as a reservoir for lubricant or grease, greatly enhancing the lubrication of the coupling and extending its life span.

1. A coupling having an inner member and an outer annular member comprising one or more pairs of members, which may or may not include one or both the innermost and outermost members, each pair being a first member and a second annular member with a common axis and having a common first centre on the axis; the first member having an outer convex spherical periphery; the second annular member having a central aperture with an inner spherical concave periphery into which the outer convex periphery of the first annular member is received; the outer convex periphery and the inner concave peripheries being concentric about the first centre and complementary to one another and co-acting with one another to transmit axial loads acting along the torsional axis between them; at least one elongate projection from one member of a pair of members into an elongate slot in the other of the pair of members, each projection and each slot being elongate in a plane containing or parallel to the central axis of the pair of members concerned, the slot and projection projecting in the direction of the said plane, and arranged to co-act with the pair of members to transmit torque from the innermost of the pair of members to the other member of the pair; the convex and concave spherical surfaces are co-acting bearing surfaces of the coupling and contiguous plain bearing surfaces which bearing radial loads of the coupling and which bear loads of the coupling acting along the torsional axis, and in which the members, other than the outer member, comprise spherical segments including a common centre.

2. A couple according to claim 1 in which each member, other than the inner member, has a pair of diametrically opposed loading slots extending half way across their width to enable the introduction of the first member of a pair of members into the concave inner periphery of the second of the pair of members, and to be retained axially by the second of the pair of members.

3. A couple according to claim 1 in which each member, other than the outer member, has a waist is its outer periphery, the width of the waist being the diameter the central aperture of the other member of the pair to enable the introduction of the first member of a pair of members into the concave inner periphery of the second of the pair of members, and to be retained axially by the second of the pair of members.

4. A coupling according to claim 1 comprising a pair of elongate projections projecting radially of the central axis of one of the pairs of members into a corresponding elongate slots in the other of the pair, the projections and slots being diametrically opposite one another and elongate in the said plane.

5. A coupling according to claim 1, wherein the radially facing periphery of each projection is spaced from the corresponding radially facing surface of the slot into which it projects.

6. A coupling according to claim 1 having one intermediate annular member, the inner and intermediate members forming one pair of members and the intermediate and outermost members forming another pair of members, with at least one projection from one of each of the pairs of members into at least one slot in the other of each of the pairs of members and the plane containing the slot(s) and projection(s) between the intermediate member and the outermost member is orthogonal to the plane containing the slot(s) and projections between the inner member and the intermediate member.

7. A coupling according to claim 1 having first, second and third intermediate members, the inner and first intermediate members forming one pair of members, first intermediate and second intermediate members being a second pair of members, the second and third intermediate members being a third pair of members, and the third intermediate and outermost members being a fourth pair of members, with at least one projection from one of each of the pairs of members into at least one slot in the other of each of the pairs of members and the plane containing the slot(s) and projection(s) between one pair of members, except the third pair of members, is orthogonal to that of the next lower ordinal pair of members preferably in which, in the case of the third pair, of members the plane containing the projections and slots is aligned with the plane containing the projections and slots of the second pair of members.

8. A coupling according to claim 7 in which the third intermediate and outermost members have a common second centre which is offset from the common first centre along the central axis when the members are aligned with the second intermediate member.

9. A coupling according to claim 8 having its outer convex spherical periphery centred on the common second centre of the third intermediate and outermost members and its inner spherical concave periphery centred on the common first centre.

10. A coupling according to claim 1 wherein the angle subtended at the centre by the inner spherical concave periphery of the second member of the pair including the inner member is greater than the angle subtended at the centre by the outer spherical convex of the inner member.

11. A coupling according to claim 1, wherein a connecting structure connects the outermost member of the coupling to the outermost or innermost member of an adjoining similar coupling.

12. A coupling according to claim 1 in which the outer member comprises a Spragg clutch or freewheel element.

13. A coupling according to claim 1 additionally comprising one or a pair of seal support member having mounted thereon one or more annular seals, the one or more seals engaging the spherical periphery of one of the said annular member inside the seal support member.

14. A coupling according to claim 13 wherein one or a pair of the seal support members comprise seal support rings, the seal support rings being mounted within one of the annular members and the annular seals engage the spherical periphery of a second of said annular members inside the annular member within which the seal support rings(s) are mounted.

15. A coupling according to claim 13 having over-pressure relief means to relieve lubricant over pressure.

16. A coupling according to claim 13 comprising an inner member, three intermediate members and an outer member wherein one or a pair of seal rings is mounted inside the outer member and with the associated seal(s) engaging the outer spherical periphery of the second of the intermediate members, and a second or second pair of seal rings is mounted inside the inner periphery of the second intermediate member with the associated seals engaging the outer periphery of the inner member.

17. A coupling according to claim 13 and having one intermediate member wherein the sides of the intermediate member incline inwards from the outer periphery of the member to the inner periphery of the member, the arrangement being such that at the rotation of the intermediate member one side is parallel to an adjacent seal support ring.

18. A coupling according to claim 13 wherein the outer annular member has a spherical outer spherical periphery and the seal support member comprises a housing having an inner hemispherical surface extending partially around the spherical outer periphery of the said outer annular member, and a seal mounted on the inner hemispherical surface of the housing and engages the spherical outer periphery of the outer annular member.

19. A coupling according to claim 18 wherein a plane passing through the edge of the seal passes through the first centre.

20. A coupling according to claim 19 wherein the housing extends beyond the seal parallel to the axis of the inner annular member and wherein the housing is formed contiguously with an input or output hub of the coupling, said hub being connected to the input or output of the coupling and projecting from the hub is a shaft and engaging with the first inner annular member of the coupling.

21. A coupling according to claim 1 and having at least one intermediate member between the inner and outer member wherein the intermediate member has at least one projection into an elongate slot the member outside the intermediate member concerned forming the second member of the pair of members which they form and in which the projection has one or more ducts from sides of the projection to the periphery of the projection in the grove and in which the sides of the projection slopes towards one another travelling from the periphery of the intermediate member concerned member towards the extremity of the projection in a slot.

22. A coupling according to claim 21 having a valve in each duct.

23. A coupling according to claim 22 wherein the valve opens to permit the passage of lubricant from the sides of the projections to the periphery of the projections under pressure of lubricant beside the side of the projection.

24. A coupling according to claim 23 wherein the valve is mounted in a plunger and the plunger moves against a spring to pump lubricant from the duct under the centrifugal force generated by rotation of the coupling.

25. A coupling according to claim 21 having circumferential grooves around the inner peripheries of the outer and the intermediate members and in the inner peripheries of the intermediate and outer periphery of the inner annular and with one or a plurality of ducts through the intermediate annular member link one circumferential groove and the other.

26. A coupling according to claim 25 having one or more ducts between the sides of the intermediate annular member and the circumferential groove in the inner periphery of the outer member or the outer periphery of the intermediate member.

27. A coupling according to claim 26 in which the duct(s) have one way valves only permitting lubricant flow from the sides to the groove.

28. A coupling according to claim 27 having a grease nipple in the outer member, said grease nipple being connected through a duct passing through the intermediate annular member to the groove in the inner periphery of the intermediate annular member or outer periphery of the inner member.
